(19) United States
(12) Patent Application Publication
(10) Pub. No.: US 2004/0038840 A1
(43) Pub. Date: Feb. 26, 2004

(54) Oxalic acid as a semiaqueous cleaning product for copper and dielectrics

(76) Inventors: Shihying Lee, Fremont, CA (US); Robert J. Small, Dublin, CA (US)

Correspondence Address: PENNIE & EDMONDS LLP, 1667 K STREET NW, SUITE 1000, WASHINGTON, DC, 20006

(21) Appl. No.: 10/421,706

(22) Filed: Apr. 24, 2003

Related U.S. Application Data
(60) Provisional application No. 60/374,819, filed on Apr. 24, 2002.

(51) Int. Cl. C11D 1/00

(52) U.S. Cl. 510/202

(57) ABSTRACT

The present invention provides a semiaqueous cleaning composition for use with aluminum, copper, and low-k substrates, the cleaning composition comprising between about 1% to about 30% oxalic acid dihydrate, between about 0.1% and about 30% of an amine, and water, wherein the cleaning composition contains less than about 0.5% fluorine-containing compounds and less than 0.5% peroxides.

### BACKGROUND OF THE INVENTION

1. Field of the Invention

This invention relates to semi-aqueous stripping and cleaning compositions that are particularly useful for stripping photoresists and cleaning organic and inorganic compounds from a semiconductor substrate, particularly including post etch, post ash residues on oxygen plasma treated substrates, and on copper and low-k dielectric wafers. The cleaning solutions contain oxalic acid dihydrate and optionally include acids, amines, corrosion inhibitors, chelating agents, and surfactants. The invention also relates to a method of using the composition on substrates.

2. Description of Related Art

During the fabrication of microcircuits, the precise positioning of a number of appropriately doped regions on a slice of semiconductor is typically followed by the positioning of one or more interconnection patterns on the semiconductor. Positively doped resists have been extensively used as masking materials to delineate patterns onto a substrate so that the patterns can be subsequently etched into, or otherwise defined in, the substrate. The final steps in preparing the substrate then involve removing the unexposed resist material and any etching residue, if etching was used, from the substrate. It is critical that as much as possible of the residue and resist be removed to provide a wafer having sufficient integrity for subsequent use of the wafer in microcircuitry.

A semiconductor integrated circuit has very fine structures. The fine circuits are generally fabricated by: uniformly coating a photoresist on an insulating film or a conductive film (such as an oxide film, an Cu film, or Al alloy film) coated on a substrate; exposing and developing the photoresist to form a certain pattern; etching the substrate, or depositing a film thereon, by using the patterned photoresist as a mask; and thereafter removing the unnecessary photoresist. Positive photoresists are used as an intermediate mask for transferring an original mask pattern of a reticle onto wafer substrates by means of a series of photolithography and plasma etching steps. The etchant gases selectively attack the unprotected area of the substrate. Liquid or wet etching chemistries have been used extensively over the years to etch metals, oxides and dielectrics. These chemistries can be very aggressive and can result in isotropic etching (etching equally in all directions).

Increasingly, plasma etching, reactive ion etching or ion milling are used, and such etching processes produce undesirable by-products from the interaction of the plasma gases, reacted species and the photoresist. The composition of such by-products is generally made up of the etched substrates, underlying substrate, photoresist and etching gases. The formation of such by-products is influenced by the type of etching equipment, process conditions and substrates utilized. These by-products are generally referred to as “sidewall polymer,” “veil” or “fences” and cannot be removed completely by either oxygen plasma or conventional solvents.

One of the steps in the microcircuit manufacturing process is the subsequent removal of the patterned photoresist films from substrates. In general, this step is conducted by one of two methods. One method involves a wet stripping step in which the photoresist-covered substrate is brought into contact with a photoresist stripper solution that consists primarily of an organic solvent and an amine.

Stripper solutions, however, cannot completely and reliably remove the photoresist films, especially if the photoresist films have been exposed to UV radiation and plasma treatments during fabrication. Some photoresist films become highly cross-linked by such treatments and are more difficult to dissolve in the stripper solution. In addition, the chemicals used in these conventional wet stripping methods are sometimes ineffective for removing inorganic residual materials formed during the plasma etching of metal or oxide layers with halogen-containing gases.

Sidewall residues have been removed with either acidic organic solvents or alkaline organic solvents. The acidic solvents are generally composed of phenolic compounds or chloro-solvent and/or an aromatic hydrocarbon and/or alkylbenzenesulfonic acids. These formulations generally need to be used at temperatures up to and beyond 100° C. These chemistries normally need to be rinsed with isopropanol.

Known photoresist stripper compositions containing a combination of a polar solvent and an amine compound include:

1. U.S. Pat. No. 4,403,029 describes alkaline/solvent mixtures useful as photoresist strippers, but not necessarily cleaners, that include dimethylacetamide or dimethylformamide and alkanolamines.

2. U.S. Pat. Nos. 4,428,871, 4,401,747, and 4,395,479 describe cleaners containing 2-pyrrolidone, dialkylsulfone and alkanolamines.

3. U.S. Pat. No. 4,744,834 describes cleaners containing 2-pyrrolidone and tetramethylammonium hydroxide.

4. U.S. Pat. No. 4,617,251 teaches a positive photoresist stripping composition containing (A) a selected amine compound (e.g., 2-(2-aminoethoxy)-ethanol; 2-(2-aminoethylamino)-ethanol; or a mixture thereof) and (B) selected polar solvents (e.g., N-methyl-2-pyrolidinone, tetrahydrofurfuryl alcohol, isophorone, dimethyl sulfoxide, dimethyl adipate, dimethyl glutarate, sulfolane, gamma-butyrolactone, N,N-dimethylacetamide or mixtures thereof). The reference further teaches that water as well as dyes or colorants, wetting agents, surfactants and antifoamers may be added into this composition.

5. U.S. Pat. No. 4,770,713 teaches a positive photoresist stripping composition containing (A) a selected amide (e.g., N,N-dimethyl acetamide; N-methyl acetamide; N,N-diethyl acetamide; N,N-dipropyl acetamide; N,N-dimethyl propionamide; N,N-diethyl butyramide or N-methyl-N-ethyl propionamide) and (B) a selected amine compound (e.g., monoethanolamine, monopropanolamine, or methyl-aminoethanol). The patent also teaches this stripper may optionally contain a water miscible nonionic detergent (e.g., alkylene oxide condensates, amides or semi-polar nonionics).

6. U.S. Pat. No. 4,824,763 teaches positive-working photoresist stripping composition containing (A) triamine (e.g., diethylene-triamine) and (B) a polar solvent (e.g., N-methyl-2-pyrrolidone, dimethylformamide, butyrolactone, aliphatic hydrocarbons, aromatic hydrocarbons, or chlorinated hydrocarbons).

7. U.S. Pat. No. 4,904,571 teaches printed circuit board photoresist stripper composition containing (A) a solvent (e.g., water, alcohols, ethers, ketones, chlorinated hydrocarbons or aromatic hydrocarbons); (B) an alkaline compound dissolved in said solvent (e.g., primary amines, secondary amines, tertiary amines, cyclic amines, polyamines, quaternary ammonium amines, sulfoniumhydroxides, alkali hydroxides, alkali carbonates, alkali phosphates or alkali pyrophosphates); and (C) a borohydride compound dissolved in said solvent (e.g., sodium borohydride, lithium borohydride, dimethyl amine borone, trimethyl amine borone, pyridane borone, tert-butyl amine borone, triethyl amine borone, or morpholine borone).

8. U.S. Pat. No. 5,102,777 teaches a positive photoresist stripper composition comprising (A) a solvent (e.g., a pyrrolidone compound, a diethylene glycol monoalkyl ether, a sulfur oxide compound, a sulfolane compound or a mixture thereof); (B) an amine (e.g., alkanolamine); and (C) a fatty acid (e.g., capric acid, lauric acid, talmitric acid, caprylic acid, myristic acid, oleic acid, stearic acid, linoleic acid, linolic acid, buthylic acid, abietic acid, isooctoic acid, isohexadecanoic acid, isostearic acid, behenic acid, undecylenic acid, hydroxystearic acid, chipanodonic acid, arachidonic acid, oleostearic acid, or 2-ethylhexadecanilic acid).

9. U.S. Pat. No. 5,279,791 teaches a stripping composition for removing resists from substrates containing (A) hydroxylamine; (B) at least one alkanolamine; and optionally (C) at least one polar solvent.

10. U.S. Pat. No. 5,308,745 teaches an alkaline-containing photoresist stripping composition comprising (A) a stripping solvent (e.g., 2-pyrrolidinone, 1-methyl-2-pyrrolidinone, 1-ethyl-2-pyrrolidinone, 1-propyl-2-pyrrolidinone, 1-hydroxyethyl-2-pyrolidinone, 1-hydroxypropyl-2-pyrrolidinone, diethylene glycol monoalkyl ethers, dialkyl sulfones, dimethyl sulfoxide, tetrahydrothiophene-1,1-dioxides, polyethylene glycol, dimethylacetamide or dimethylformamide; (B) a nucleophilic amine (e.g., 1-amino-2-propanol, 2-(2-aminoethoxy) ethanol, 2-aminoethanol, 2-(2-aminoethylamino)-ethanol or 2-(2-aminoethylamino) ethylamine); and (C) a non-nitrogen containing weak acid (e.g., acetic acid, phthalic acid, 2-mercaptobenzoic acid, 2-mercaptoethanol, 1,3,5-trihydroxybenzene, pyrogallol, resorcinol, 4-tert-butylcatechol, carbonic acid or hydrofluoric acid).

11. U.S. Pat. No. 5,334,332 teaches a photoresist resist stripping and cleaning composition comprising (A) hydroxylamine; (B) at least one alkanolamine; (C) water; (D) optionally, at least one polar solvent; and (E) optionally, a chelating reagent (e.g., thiophenol, ethylenediamine tetraacetic acid or 1,2-dihydroxybenzene) to reduce the surface metal contamination on wafers.

12. U.S. Pat. No. 5,399,464 teaches a stripping composition for removing positive organic photoresist from a substrate comprising (A) a triamine (e.g., diethylene triamine); (B) a nonpolar or polar organic solvent (e.g., N-methyl pyrrolidone).

13. U.S. Pat. No. 5,417,802 teaches a material useful for photoresist removal or post-metal etch clean up that comprises (A) a primary or secondary amine; (B) a solvent (e.g., dimethyl sulphoxide or dimethylacetylamide); and (C) organic ligands such as crown ethers or cyclodextrines.

14. Japanese Patent Application No. 63-208043 teaches a positive-working photoresist stripper composition containing (A) 1,3-dimethyl-2-imidazolidinone; (B) a water-soluble organic amine (e.g., monoethanolamine, 2-(2-aminoethoxy)-ethanol, or triethylenetetramine). The application also teaches a surfactant may be added to the stripper.

15. Japanese Patent Application No. 64-081949 teaches a positive-working photoresist stripper composition containing (A) a solvent (e.g., gamma-butyrolactone, N-methyl-formamide, N,N-dimethylformamide, N,N-dimethyl-acetamide or N-methylpyrrolidone); (B) an amino alcohol (e.g., N-butyl-ethanolamine or N-ethyldiethanolamine); and (C) water.

16. Japanese Patent Application No. 4-350660 teaches a stripper for positive photoresists comprising (A) 1,3-dimethyl-2-imidazolidinone (DMI), (B) dimethylsulfoxide (DMSO), and (C) a water-soluble amine (e.g., monoethanolamine or 2-(2-amino-ethoxy)ethanol), wherein the amount of the water-soluble amine is 7-30% by weight.

17. Japanese Patent Application No. 1999-197523 describes a stripper composition for photoresist used in manufacture of liquid crystal display device that includes 5-15 weight % of alkanolamine, 35-55% sulfoxide or sulfone compound, and 35-55 wt. % glycol ether.

18. Japanese Patent Application No. 08087118 describes a stripper composition that includes 50-90 weight % of alkanolamine, and 50-10% dimethyl sulfoxide or N-methyl-2-pyrrolidone.

19. Japanese Patent Application No. 03227009 describes a stripper composition that includes ethanolamine and dimethyl sulfoxide.

20. Japanese Patent Application No. 07069619 describes a stripper composition that includes alkanolamine, dimethyl sulfoxide, and water.

21. U.S. Pat. No. 5,480,585 and Japanese Patent Hei. 5-181753 disclose organic strippers comprising alkanolamine, a sulfone compound or a sulfoxide compound, and a hydroxyl compound.

22. The Japanese Laid-open Patent No. 4-124668 discloses a photoresist stripping composition including 20-90% by weight of an organic amine, 0.1-20% by weight of phosphoric ester surfactant, 0.1-20% by weight of 2-butyne-1,4-diol, and the remainder glycol monoalkylether and/or an aprotic polar solvent.

23. The Japanese Laid-open Patent Sho. 64-42653 discloses a photoresist stripping composition comprising over 50% by weight of dimethylsulfoxide (more desirably over 70% by weight), 1 to 50% by weight of a solvent such as diethyleneglycol monoalkylether, diethyleneglycol dialkylether, gamma-butyrolactone or 1,3-dimethyl-2imidazoledinone, and 0.1-5% by weight of a nitrogen-including organic hydroxyl compound, such as monoethanolamine. The reference recites that the amount of dimethylsulfoxide less than 50% by weight causes great reduction in stripping force, while the amount of nitrogen-including organic hydroxyl compound solvent over 5% by weight corrodes the metal (e.g., aluminum) film.

24. U.S. Pat. No. 5,091,103 to Dean et al. teaches a positive photoresist stripping composition containing: (A) N-alkyl-2-pyrrolidone; (B) 1,2-propanediol; and (C) tetraalkylammonium hydroxide.

25. Japanese Patent Application No. 10028482 describes a cleaning composition that includes an oxidizing agent, for example a peroxide, and an organic acid, for example formic acid, acetic acid, oxalic acid, or maleic acid. After cleaning, residual resist are removed with a stripper.

26. Japanese Patent Application No. 08050018 describes a cleaning composition that includes a chelating agent, for example citric acid, oxalic acid, or EDTA, and a photocatalyst, for example titanium oxide, SnO2, WO3, or SiO2.

27. Japanese Patent Application No. 06056109 describes a method of preparing electrolysis water that includes adding at most 0.08 moles per liter of an organic salt, for example ammonium oxalate.

28. Japanese Patent Application No. 0901475 filed Jul. 28, 1997, describes a cleaning composition for semiconductors that includes a fluorine-containing compound, a water-soluble organic solvent, an organic or inorganic acid, and optionally an organic acid ammonium salt to clean ashed resist from a semiconductor.

29. U.S. Pat. No. 5,780,406 describes a non-corrosive cleaning composition for removing plasma etching residues that includes water; an hydroxylammonium compound, for example bi- or triethylamine compound, bi- or triethanolamine and the like; a basic compound selected from amines and quaternary ammonium hydroxides, and optionally a chelating agent and/or surfactant, wherein the pH is between 2 and 6.

30. U.S. Pat. No. 5,630,904 describes a cleaning composition for removing dry etching photoresist residues that includes 5% to 50% of an organocarboxylic ammonium salt or amine carboxylate, and from 0.5% to 15% of a fluorine compound.

31. WO-09800244 describes a wafer cleaning composition that has 2-98% of a chelating agent, for example malonic acid, oxalic acid, or tetrafluoroacetic acid; and 2-98% of a solvent, such as water, NMP, or BLO.

32. EP 00474053 BI describes a cleaner having from 51% to 95% of a liquid hydrocarbon solvent, excluding terpene; 1 to 25% of a nonionic ethoxylate emulsifier; and 1 to 25% of a dibasic ester of dicarboxylic acids, for example oxalic acid, malonic acid, adipic acid, and the like.

33. U.S. Pat. No. 6,030,932 describes a cleaning composition for removing photoresist, plasma etch, and CMP residue that includes an hydroxylamine or an amine, a fluorine-containing compound, and water.

34. U.S. Pat. No. 5,800,726 describes a etching composition that includes 10-25 grams EDTA, 15-35 grams of a salt of phosphoric acid, 25-45 grams oxalic acid, and a liter of 30% hydrogen peroxide.

Such stripping compositions, however, have only proven successful in cleaning “sidewall polymer” from the contact openings and metal line etching in simple microcircuit manufacturing involving a single layer of metal process when the metal structure involves mainly Al—Si or Al—Si—Cu and the “sidewall polymer” residue contains only an organometallic compound with aluminum. Many of the stripping and cleaning compounds are incompatable with, i.e., cause excessive etching, swelling, or change in the refractive index (RI) of copper, copper-ER, or a variety of low-k substrates.

Depending on the constituents of the compositions and the ratio thereof, the aforementioned stripping compositions exhibit greatly different characteristics in photoresist stripping force, metal corrosion properties, the complexities of a rinsing process following the stripping, environmental safety, workability and price.

If etching residue is not removed from the substrate, the residue can interfere with subsequent processes involving the substrate. The need to effectively remove etching residue and photoresist from a substrate becomes more critical as the industry progresses into submicron processing techniques. The requirement for cleaning solutions that remove all types of residue generated as a result of plasma etching of various types of metals, such as aluminum, aluminum/silicon/copper, titanium, titanium nitride, titanium/tungsten, tungsten, silicon oxide, polysilicon crystal, etc., while not corroding the underlying metal presents a need for more effective chemistry in the processing area. The effect of poor cleaning results in low device yield, low device reliability, and low device performance.

Also, if the components in these residues are not removed or neutralized in some manner then the residues will absorb moisture and form acidic species that can corrode the metal structures. The resultant acid corrodes wiring materials to bring about an adverse effect such as an increase in electrical resistance and wire disconnection. Such problems frequently occur, in particular in aluminum and aluminum alloys generally used as wiring material. The wafer substrate in contact with acidic materials, if not controlled, can destroy the metal structures. Following completion of the etching operation it is necessary that the post-etch resist mask be removed from the protective surface to permit finishing operations.

An alternative method of removing photoresist film involves exposing a photoresist-coated wafer to oxygen plasma in order to burn the resist film from the substrate surface in a process known as oxygen plasma ashing. Oxygen plasma ashing has become more popular in the microcircuit manufacturing process because it is carried out in a vacuum chamber and, hence, is expected to be less susceptible to airborne particulate or metallic contamination. Oxygen plasma ashing, however, is not fully effective in removing plasma-etching residues noted above. Instead, removal of these plasma-etching residues must be accomplished by subsequently exposing the photoresist film to certain solutions. Generally, this exposure at least consists of first rinsing the substrate with an organic solvent (most commonly isopropyl alcohol) followed by a second rinsing operation with deionized water. Besides isopropyl alcohol, specific teachings of alternative organic solvent rinse solutions are described in U.S. Pat. Nos. 4,786,578 (Neisius et al.) (an organic base such as triethanolamine in combination with a non-ionic surfactant); 4,824,762 (Kobayashi et al.) (an ether and optionally, an amine compound such as monoethanolamine); and 5,174,816 (Aoyama et al.) (an aqueous solution of a quarternary ammonium hydroxide in combination with a sugar or sugar alcohol). The use of such organic solvent-containing rinses, however, are not necessarily desirable because they add complexity to the photoresist removal operation and generate additional solvent waste.

Other commercial products are also available to clean the post-etch residues left by plasma etching followed by oxygen ashing. For example, EKC 265 (TM), available from EKC Technology, Inc., is a plasma etching cleaning solution composed of water, alkanolamine, catechol and hydroxylamine. Catechol is not very effective under acidic conditions. Therefore, EKC 265 can badly corrode copper especially when used with low K films. Such a composition is disclosed in U.S. Pat. No. 5,279,771 to Lee. ACT 935 (TM), available from Ashland Chemical, is another plasma etching cleaning solution and is composed of water, alkanolamine and hydroxylamine. In both cases, hydroxylamine may be used as a corrosion inhibitor. R-10 (TM), a post-strip rinse available from Mitsubishi Gas Chemical, is composed of water, alkanolamine and a sugar alcohol, wherein the sugar alcohol acts as a corrosion inhibitor.

Although these commercial products can effectively dissolve plasma-etching residues, the combination of water and alkanolamine contained therein can also attack the metallic layers deposited patternwise on the substrate. The addition of a corrosion inhibitor to these products can mitigate to a certain extent the unwanted attack on the metallic layers and oxide layers deposited on the substrate. However, since these products have a pH above 11, even in the presence of a corrosion inhibitor, they may attack certain corrosion-sensitive metal layers. Particularly, metal layers such as aluminum or aluminum alloys (e.g., Al Cu Si), titanium nitride, titanium tungsten and the like are particularly corrosion sensitive. Furthermore, while the addition of a suitable corrosion inhibitor is essential to prevent corrosion of the substrate metal layers, the corrosion inhibitor must not inhibit the removal of the plasma-etching residue.

Commercial cleaning solutions were tested on an oxide/SiLK wafer after delamination was observed in SiLK CMP when commercial products were utilized. Cleaved sample pieces were immersed in the solutions for two minutes at room temperature, and extensive delamination was somewhat visible.

It is difficult to balance effective plasma etching residue removal and corrosion inhibition because chemical compositions of the plasma etching residues are generally similar to those of the metal layers or oxide layers on the substrate. The alkanolamine used in the prior art cleaning compositions was oftentimes found to attack both the plasma etching residues and the substrate metal layers in the presence of water. Moreover, if a post-cleaner rinse (such as isopropyl alcohol) was not used, the corrosion could be very severe. In addition, some types of the corrosion inhibitors have been found to retard plasma etching residue removal. There has also always been a tradeoff between speed of plasma etching residue removal and substrate metal layer corrosion inhibition. Accordingly, there remains a need for a method of quickly and effectively removing the cured photoresist and plasma etching residues without causing metal layer corrosion.

The demand for new wafer cleaning technology for use after etching and resist removal increases as the industry enters into submicron processing techniques. The requirement for a cleaning solution to remove all types of residue generated as a result of plasma etching of various types of metals (e.g., aluminum, aluminum/silicon/copper, titanium, titanium nitride, titanium/tungsten, tungsten, silicon oxide, polysilicon crystal, etc.) presents a need for more effective chemistry in the processing area. It is believed that the present invention offers a solution to that need.

### SUMMARY OF THE INVENTION

Accordingly, the present invention is directed to semiaqueous cleaning compositions including oxalic acid and water for use in removing post-etch residues remaining on substrate surfaces after oxygen plasma treatment, and a method of using the compositions to remove photoresist.

The compositions alternatively, additionally, or optionally include: other acids, e.g., dicarboxylic, monocarboxylic, hydroxy-carboxylic, amino-carboxylic, sulfano-carboxylic, amino-sulfano, and inorganic acids; amines, e.g., primary/secondary/tertiary amines, and hydroxylamines, alkanolamines.

Specific examples of compounds advantageously included include:maleic, ascorbic, glycolic, and sulfamic acids; monoethanolamine (MEA), diethanolamine, propylamine, choline hydroxide, ammonium hydroxide.

Other optional components include: corrosion inhibitors, e.g., benzotriazole, thiourea, ammonium bisulfite, choline bisulfite, propylene glycol, glycerol, sorbitol, gelatine, starch, phosphoric acid, silicic acid polyethylene oxide, and polyethylene imine; chelating agents, e.g., dicarboxylic acids, hydroxy-carboxylic acids, amino-carboxylic acids, diamine, polyalcohol, polyethylene oxide and polyamine/imine; and surfactants, e.g., polyvinyl alcohol, polyethylene oxide, polyethylene imine, polyalcohol, polyether, and polyamine/imine.

The invention further contemplates a method of using semiaqueous cleaning compositions including oxalic acid and water to remove post-etch residues from substrates including, but not limited to, conventional aluminum metal line/pad or oxide wafers, aluminum/low-k dielectric wafers, advanced copper/low-k dielectric wafers, and advanced compound semiconductor wafers such as gallium arsenide (GaAs) or indium phosphide (InP).

One embodiment includes a semiaqueous cleaning composition for use with aluminum, copper, and low-k substrates, the cleaning composition comprising between about 1% to about 30% oxalic acid dihydrate, between about 0.1% and about 30% of an amine, and water, wherein the cleaning composition contains essentially no, i.e., less than about 0.5%, preferably less than 0.1%, of fluorine-containing compounds and less than 0.5% peroxides. Another embodiment includes a semiaqueous cleaning composition which additionally comprising a second organic acid, an inorganic acid, or mixture thereof, wherein the pH of the composition is between about 2 and 12. The organic acid is selected from dicarboxylic, monocarboxylic, hydroxy-carboxylic, amino-carboxylic, sulfano-carboxylic, and amino-sulfano acids.

Another embodiment includes a cleaning composition comprising between about 1% to about 30% oxalic acid dihydrate, between about 0.1% and about 30% of an amine, and water, wherein the cleaning composition contains less than about 0.5% fluorine-containing compounds and less than 0.5% peroxides, and additionally comprising at least one hydroxylamine.

Another embodiment includes a cleaning composition comprising between about 1% to about 30% oxalic acid dihydrate, between about 0.1% and about 30% of an amine, and water, wherein the cleaning composition contains less than about 0.5% fluorine-containing compounds and less than 0.5% peroxides, additionally comprising benzotriazole, thiourea, ammonium bisulfite, choline bisulfite, propylene glycol, glycerol, sorbitol, gelatine, starch, phosphoric acid, silicic acid polyethylene oxide, polyethylene imine, or mixture thereof in an amount sufficient to reduce etching of the substrate contacting the cleaner.

Another embodiment includes a cleaning composition comprising between about 1% to about 30% oxalic acid dihydrate, between about 0.1% and about 30% of an amine, and water, wherein the cleaning composition contains less than about 0.5% fluorine-containing compounds, less than about 0.1% of organic solvents, and less than 0.5% peroxides, and additionally comprising at least one chelating agent. The chelating agent may be selected from dicarboxylic acids, hydroxy-carboxylic acids, amino-carboxylic acids, diamine, polyalcohol, polyethylene oxide and polyamine/imine.

The semiaqueous cleaning compositions of this invention may additionally include between 0.01% and 1% of polyvinyl alcohol, polyethylene oxide, polyethylene imine, polyalcohol, polyether, polyamine/imine, or mixture thereof.

In a preferred embodiment the semiaqueous cleaning composition will further comprising between about 0.01% and about 10% of an oxygen scavenger, for example a sulfite.

In a preferred embodiment the oxalic acid dihydrate concentration is between about 2% and about 20%, and the pH is between about 4 and 7.

Advantageously, the semiaqueous cleaning composition further comprising a second organic acid, for example citric acid, formic acid, or a mixture thereof, wherein the total organic acid concentration is less than about 20% total organic acids, and wherein the oxalic acid dihydrate concentration is between about 4% and about 12%.

In some embodiments the semiaqueous cleaning composition this invention may additionally include between about 0.01% and about 6% of an inorganic acid.

In one embodiment, the amine is one or more alkanolamines in am amount ranging from about 1% and about 15%.

A preferred semiaqueous cleaning composition includes between about 3% and about 15% of oxalic acid; between about 3% and about 20% of a second organic acid; between about 3% and about 30% of an amine; and between about 1% and about 15% of a chelating agent, with the balance water.

Another semiaqueous cleaning composition includes about 3% to about 8% by weight oxalic acid dihydrate, about 22% to about 30% tetramethylammonium hydroxide, and about 64% to about 74% water.

Another semiaqueous cleaning composition includes about 2% to about 8% oxalic acid dihydrate; about 7% to about 13% formic acid; about 1% to about 15% of ammonium hydroxide, an amine, or mixture thereof; and about 72% to about 90% water.

One exemplary semiaqueous cleaning composition includes from about 83 to about 95% water; from about 2 to about 10% of oxalic acid dihydrate; and from about 1 to about 10% monoethanolamine.

Another exemplary cleaning composition includes from about 83 to about 95 parts water; from about 2 to about 10 parts of oxalic acid dihydrate; from about 1 to about 10 parts monoethanolamine, and from about 0.1 to about 4 parts of a sulfite.

Another exemplary cleaning composition includes from about 87% to about 98% water; from about 1% to about 6% parts of oxalic acid dihydrate; and from about 1% to about 7% of a substituted or unsubstituted amine.

Another exemplary cleaning composition includes from about 5% to about 15% oxalic acid dihydrate, from about 5% to about 15% of choline, and from about 70 parts to about 90 parts water, wherein the pH of this composition is between about 3 and about 8.

Another exemplary cleaning composition includes about 7% to about 13% of oxalic acid dihydrate, about 5% to about 13% tetramethylammonium hydroxide, and between 0% to about 5% of a sulfite.

Another exemplary cleaning composition includes about 8 to about 12% oxalic acid dihydate; about 3 to about 7% wt % tetramethylammonium hydroxide; and about 80 to about 90% water.

The compositions show best performance when matched to various substrates. A semiaqueous cleaning composition for use with aluminum, copper, and low-k substrates, includes between about 7% to about 13% oxalic acid dihydrate, about 10% to about 15% tetramethylammonium hydroxide, and about 65% to about 85% water.

Another semiaqueous cleaning composition includes about 87 to about 94% water; about 3 to about 7% oxalic acid dihydrate; about 3 to about 7% monoethanolamine, and about 0.1 to about 4% of a sulfite salt.

In one preferred embodiment the amine comprises diglycolamine, choline, or a mixture thereof.

One preferred embodiment is semiaqueous cleaning composition including between about 2 and about 9% oxalic acid dihydrate, between about 2 and about 15% formic acid, between about 0.5 and about 5% ammonium hydroxide, and between about 71 and about 95% water.

The invention also relates to a method of cleaning a semiconductor substrate including the steps of: contacting the substrate with a semiaqueous cleaning composition of this invention for between about 5 minutes and about 60 minutes and at a temperature of between about 20 C to about 85 C; and rinsing the cleaned substrate to remove the cleaning composition.

A preferred method of cleaning a semiconductor substrate includes contacting the substrate with a semiaqueous cleaning composition comprising between about 7% to about 13% oxalic acid dihydrate, about 2% to about 8% tetramethylammonium hydroxide, and about 80% to about 90% water for between about 5 minutes and about 60 minutes and at a temperature of between about 20 C to about 85 C; and rinsing the cleaned substrate to remove the cleaning composition with water, an alcohol, or a mixture thereof.

Another method of cleaning a semiconductor substrate includes contacting the substrate with a semiaqueous cleaning composition comprising between about 1% to about 30% oxalic acid dihydrate, between about 0.1% and about 10% of ammonia hydroxide, and water for between about 5 minutes and about 60 minutes and at a temperature of between about 20 C to about 85 C; and rinsing the cleaned substrate to remove the cleaning composition.

Yet another method of cleaning a semiconductor substrate includes contacting the substrate with a semiaqueous cleaning composition comprising between about 1% to about 30% oxalic acid dihydrate, between about 0.1% and about 25% of hydroxyamines or salts thereof, and water, wherein the cleaning composition contains no, i.e. less than about 0.5% fluorine-containing compounds and less than 0.5% peroxides for between about 5 minutes and about 60 minutes and at a temperature of between about 20 C to about 85 C; and rinsing the cleaned substrate to remove the cleaning composition.

Yet another method of cleaning a semiconductor substrate includes contacting the substrate with a semiaqueous cleaning composition comprising about 3% to about 15% oxalic acid dihydrate, wherein the pH of the composition is between about 1 and about 12, for between about 5 minutes and about 60 minutes and at a temperature of between about 20 C to about 85 C; and rinsing the cleaned substrate to remove the cleaning composition.

### DESCRIPTION OF THE PREFERRED EMBODIMENTS

As used herein, the term “semiaqueous” refers to a mixture of water, organic material and/or inorganic material where the amount of water must be about 10% to about 99% water, preferably between about 30% and about 95% water, and even more preferably between about 60% and about 90% water.

The following abbreviations may be used herein:

TBPH=tetrabutyl phosphonium hydroxide;

DCH=dicarbethoxy hydrazine;

TMAF=tetramethylammonium formate;

TMAH=tetramethylammonium hydroxide;

MEA=monoethanolamine, Ethanolamine, 2-Aminoethanol; [141-43-5];

NMP=N-methyl pyrrolidone;

PG=propylene glycol;

PC=propylene carbonate;

HDA®=hydroxylamine;

DEHA=diethylhydroxylamine;

MIPA=monoisopropanolamine;

DMPD=1,3- and 1,5-Dimethyl-2-piperidone, [1690-76-2] and [86917-58-0], a mixture;

Gamma-BLO=4-Hydroxybutyric acid gamma-lactone, gamma-Butyrolactone, [96-48-0];

MMEA=2-(Methylamino)ethanol, Monomethylethanolamine; [109-83-1];

DEA=Diethanolamine, 2,2′-minodiethanol; [111-42-2];

DGA=Diglycolamine, Diethylene glycolamine, 2-(2-Aminoethoxy)ethanol; [929-06-6];

ABF=Ammonium BiFluoride;

HEP=N-(2-hydroxyethyl)-2-pyrrolidone;

AH=ammonium hydroxide;

CAT—catechol; and

CA=citric acid.

The compositions are available for use on most substrates, i.e., both metal and low-k dielectric substrates, and resists. The composition is particularly useful on post-etch residues of either Novolac or polyhydroxystyrene type photoresists.

The compositions of the present invention are beneficially essentially free of HF or fluoride. Such compositions result in increased corrosion of metal and other substrates.

Acidic formulations described herein are better for cleaning for certain low K substrates compared to fluoride formulations. Advantageously in certain embodiments, the pH of the cleaning compositions are acidic, i.e. pH below 7.

The composition contains at least 1%, more preferably at least 5% of a carboxylic acid. In one embodiment the composition contains between 1% and about 30% oxalic acid, preferably between about 2% and about 20%, more preferably between about 4% and about 12% oxalic acid.

All oxalic acid concentrations are given as weight percent oxalic acid dihydrate.

Occasionally, the compositions are given in “parts”, which mean parts by weight of a composition that has nominally 100 parts total, i.e., 90 parts to 110 parts total.

In one embodiment the semiaqueous composition contains preferably between about 2% and about 20%, more preferably between about 4% and about 12% of oxalic acid, and further contains additional organic acid, such that the total organic acid concentration is less than about 25%, more preferably less than about 20% total organic acids (oxalic acid dihydrate plus other organic acids). The organic acids can include mono-, di-, and tri-carboxylic acids, hydroxy-carboxylic acids, aminocarboxylic acids, sulfanocarboxylic acids. Exemplary useful organic acids include formic, adipic, acetic, propionic, n-butyric, isobutyric, benzoic, ascorbic, glycolic, gluconic, malic, malonic, succinic, tartaric, citric, gallic acid, and mixtures thereof. A preferred organic acid includes formic acid.

One embodiment includes in addition to oxalic acid one or more inorganic acids, for example nitric, sulfuric, phosphoric, hydrochloric acids (though hydrochloric acid can be corrosive to metals), and/or amino-sulfano acids, sulfamic acids, and the like. These acids are typically present in concentrations of about 6% or less, preferably about 2% or less.

Advantageously there is in one embodiment the semiaqueous oxalic acid (and optionally other organic and/or inorganic acids) composition which further contains at least one of ammonia hydroxide (substituted or unsubstituted), other amine(s), hydroxyamine(s), alkanolamine(s), or mixture thereof admixed in. Suitable basic amine compounds include the following and mixtures thereof: hydroxylamine, hydrazine, 2-amino-2-ethoxy ethanol (DGA), monoethanolamine (MEA), diethylhydroxylamine, cholines, tetramethylammonium formate (TMAF), monoisopropanolamine (MIPA), diethanolamine (DEA), triethanolamine (TEA), 2-(2-aminoethoxy)ethanol, 2-(2-aminoethylamino)ethanol, diethanolamine, triethanolamine, or mixtures thereof.

If ammonia hydroxide is present, it is advantageously present in an amount between about 0.1% and about 10%, preferably between about 1% and about 5% ammonium hydroxide.

The amine, for example trimethylammonium hydroxide, is advantageously present in am amount ranging from about 0.1% to about 20%, preferably between about 1% and about 15%, and even more preferably between about 1.5% to about 10%. Exemplary amines include hydrazine, cholines, tetramethylammonium formate, as well as primary, secondary, or tertiary amines, or mixtures thereof.

Hydroxylamines, if present, are advantageously present in an amount less than 12%, advantageously in an amount between about 0. 1% and about 10%, for example between about 1% and about 5% of one or more hydroxylamines. Advantageously, the concentration of hydroxylamines is below 9% if the pH is acidic. Exemplary hydroxylamines include hydroxylamine (HDA®), diethylhydroxylamine, or mixtures thereof.

Salts of hydroxyamines, for example, hydroxylamine nitrate, hydroxylamine sulfate, or mixtures thereof, can be present in concentrations about two times greater than the ranges given for hydroxylamines. For example, a mixture of the invention with between about 15% to about 25% of hydroxylamine sulfate would be within the invention.

The alkanolamine(s), if present, is advantageously present in am amount ranging from about 0.1% to about 20%, preferably between about 1% and about 15%, and even more preferably between about 1.5% to about 10%. Exemplary alkanolamines include monomethylethanolamine, monoisopropanolamine (MIPA), diethanolamine (DEA), triethanolamine (TEA) or a mixture thereof.

If combinations of amines, alkanolamines, and/or hydroxylamines are used in a composition, the concentration should be reduced accordingly to not exceed the about 20% given as a preferred upper limit for amines.

One preferred embodiment is a semiaqueous composition comprising between about 3% and about 15%, preferably between about 5% and about 10%, of oxalic acid; optionally between about 3% and about 20%, preferably between about 5% and about 10%, of one or more additional organic acids, preferably such that the total organic acid concentration, i.e., oxalic acid dihydrate plus other organic acids, is less than about 25%; optionally between about 3% and about 30% of a substituted or unsubstituted ammonium hydroxide; optionally between about 1% and about 15% of a chelating agent; and optionally less than about 3% of one or more of corrosion inhibitors and surfactants.

Other performance chemical additives, for example surfactants, chelating agents, corrosion inhibitors, and the like, can be added. Preferably, the total concentration of these is below about 10% by weight, more preferably below about 5% by weight.

Cleaning and corrosion vary with pH for many of these compositions. It is preferred to vary pH to meet the specific requirements of the substrate by adding, for example, organic acids and amines to achieve a pH of between 4 and 12. A pH of between about 4 and 7, say about 5, will provide cleaners of this invention that are most compatible with low-k dielectrics, for example HSQ.

In one embodiment the cleaner further comprises ethylene diamine, DETA, or a mixture thereof.

Suitable corrosion inhibitors include inorganic nitrate salts such as ammonium, potassium, sodium and rubidium nitrate salts, aluminum nitrate and zinc nitrate. Other corrosion inhibitors include salicyl alcohol, salicyl aldoxime, gallic acid, gallic acid esters and pyrogallol.

Suitable chelating agents are described in commonly assigned U.S. Pat. No. 5,672,577, issued Sep. 30, 1997 to Lee, which is incorporated herein by reference. One suitable chelator is EDTA. Others, including DTPA, can be used. The addition of a chelator can further improve the effectiveness of the formulation used as a etch residue or photoresist remover.

Suitable surfactants are selected from nonionic types, cationic types and anionic types of surfactants. Suitable surfactants include poly(vinyl alcohol), poly(ethyleneimine) and any of the surfactant compositions classified as anionic, cationic, nonionic, amphoteric, and silicone-based. Preferred surfactants are poly(vinyl alcohol) and poly(ethyleneimine). Preferably, a surfactant is present in the cleaning composition of the present invention, typically in the amount of about 1 ppm to 500 ppm by weight based on the total weight of the cleaning composition.

Unless otherwise specified, the compositions are given in weight percent.

One preferred embodiment of the present invention is a cleaning composition containing 3% to 8% by weight oxalic acid dihydrate, 22% to 30% tetramethylammonium hydroxide (TMAH), and 64% to 74% water, and optionally containing acids, corrosion inhibitors, chelating agents, and/or surfactants.

Another embodiment is a cleaning composition containing about 7% to about 13% oxalic acid dihydrate, about 2% to about 8% TMAH, about 80% to about 90% water, and optionally also containing acids, corrosion inhibitors, chelating agents, and/or surfactants.

Another embodiment is a cleaning composition containing about 7% to about 13% oxalic acid dihydrate and about 82% to about 93% water, and optionally also containing acids, corrosion inhibitors, chelating agents, and/or surfactants.

Another embodiment is a cleaning composition containing about 7% to about 13% oxalic acid dihydrate, about 40% to about 60% TMAH, and about 35% to about 45% water, and optionally also containing acids, corrosion inhibitors, chelating agents, and/or surfactants.

Another embodiment is a cleaning composition containing about 2% to about 8% oxalic acid dihydrate; about 7% to about 13% formic acid; about 1% to about 5% ammonium hydroxide (NH4OH), or alternatively about 5% to about 15% of an amine; and about 72% to about 90% water, and optionally also containing acids, corrosion inhibitors, chelating agents, and/or surfactants.

Another embodiment is a cleaning composition containing between about 1% and about 5% oxalic acid dihydrate, about 7% to about 17% formic acid, about 1% to about 5% NH4OH, and about 72% to about 92% water, and optionally also containing acids, corrosion inhibitors, chelating agents, and/or surfactants.

In a particularly preferred embodiment, a cleaning composition contains acids at about 5 wt % to about 18 wt % combined, and about 3 wt % to about 12 wt % individually, substituted or unsubstituted ammonium hydroxide at about 0 wt % to about 50 wt %, and water at about 40 wt % to 90 wt %. The acids can include one or more organic acids and optionally one or more inorganic acids. Preferably one inorganic acid is oxalic acid.

At least a portion of the acid need not be added to the composition in the acid form, but can rather be added as a salt.

Advantageously, the composition contains no oxidizers such as peroxides. These compositions lose effectiveness over time, and are not compatible with many low-k substrates.

Advantageously, the compositions of the present invention contain little, i.e., less than about 0.5%, preferably less than about 0.3%, of fluoride compounds, including ammonium bifluoride. In selected preferred embodiments, the compositions of the present invention contain no, i.e., less than about 0.1%, preferably less than about 0.01%, of fluoride compounds. The fluoride-based chemistry (exemplified by ARX60 composition in the Examples) causes unacceptable etching rates on many substrates.

Advantageously, then compositions of the invention contain no, i.e., less than about 0.1%, preferably less than about 0.01%, of hydroxylamines when used with certain substrates, as shown in the Examples. Hydroxylamines cause delamination in certain low-k substrates.

Advantageously, the compositions of the present invention contain no, i.e., less than about 0.1%, preferably less than about 0.01%, of organic solvents. Solvents cause environmental, disposal, and operational problems.

The preferred compositions of the invention comprise each of oxalic acid, an amine, and water. Oxalic acid was found to be less corrosive and more compatible with low k substrates than other acid based chemistries.

Advantageously, the cleaners of the present invention, particularly those comprising oxalic acid and an amine, can remove resist, ashed material, and the like without unacceptably etching the substrate. The compositions of the current invention and the temperatures are advantageously selected to clean the substrate in 30 minutes or less, preferably 15 minutes or less; to provide a substrate etch (or growth) rate of less than 3 angstroms per minute, preferably less than 1 angstrom per minute, when contacting the substrate for 15 minutes at the desired cleaning temperature; and change the refractive index by less than 0.005, preferably by less than 0.003, when contacting the substrate for 15 minutes at the desired cleaning temperature.

Advantageously, the pH of the cleaner is between 2 and 12, preferably between 4 and 10. For low k substrates, the pH of the cleaner is preferably between about 4 and about 6.

Advantages of the aqueous-based cleaners of the present invention include excellent cleaning, compatibility with low-k materials, low toxicity, very low cost, fewer quality control issues, ease of disposal, low viscosity, i.e., less than 5 centipoise, for example near 1 centipoise at 50 C, which allows for spray application, and usefulness for metal and conventional applications. The cleaners of the present invention are particularly useful for low-k/Al and low-k/Cu substrates.

In one embodiment, there is no hydroxlyamine. The presence of hydroxylamine was found to cause delamination of the oxide hardmask for low-k dielectric SiLK.

The method of cleaning substrates, particularly low-k substrates, is also contemplated to be part of this invention. As shown in the examples below, certain compositions perform particularly well with certain substrates The following examples are illustrative of compositions of the present invention. As used herein, % and “parts” are % by weight and parts by weight.

### EXAMPLE 1

A cleaning composition containing 10 wt % oxalic acid dihydrate, 5 wt % TMAH, and 85 wt % water was tested on a set of DPS etch DOE wafers. The wafers were Al stacks with 0.5% Cu. The set comprised nine wafers, each for a point from a 9-point DOE. The bias power varied from 120 to 180 to 240W, BC13 flow varied from 20 to 30 to 40 sccm, and nitrogen flow varied from 0 to 5 to 10 sccm. Several parameters were constant: pressure (10 mTorr), source power (1200 W), and C12 flow (100 sccm). The wafers were immersed into the chemistry solution for cleaning for 10 minutes at 45C. SEM was performed to evaluate cleaning and corrosion effects. Residue removal and corrosion effects were assessed by visual comparisons.

The results showed that the chemistry cleaned effectively. Further, for samples of 0 or 5 sccm nitrogen flow and a lower bias power (120 and 180W), samples were cleaned completely.

### EXAMPLE 2

Cleaning compositions containing the ingredients of oxalic acid dihydrate, TMAH, and water, including the solution used in Example 1, were tested on a variety of metal wafer samples (e.g., VLSI Metal, WSMC 0.35 SRAM M2, and TI-Acer M3-MXP). The variable was the quantity of a chelating agent added. SEM was performed to evaluate cleaning and corrosion effects. Residue removal and corrosion effects were assessed by visual comparisons.

The results showed that the chemistry with the higher chelator/amine ratio cleaned more aggressively and removed heavier residues. Lighter residues were removable by the chemistry with the lower chelator/amine ratio.

### EXAMPLE 3

A group of cleaning compositions containing the ingredients of oxalic acid dihydrate, water, and, optionally, TMAH were tested for their low-k dielectric and metal compatability on a variety of substrates. HSQ was used as a benchmark for low-k dielectric compatibility due to its high chemical sensitivity and tendency to degrade. SEM was performed to evaluate cleaning and corrosion effects. Residue removal and corrosion effects were assessed by visual comparisons.

The composition of the cleaners was as follows:

SLX261=80 parts water, 20 parts hydroxylamine sulfate;

SLX263=95 parts water, 5 parts hydroxylamine, 2 parts oxalic acid dihydrate;

SLX263B=98 parts water, 1.25 parts oxalic acid dihydrate, 0.6 parts NH4OH (pH=5);

SLX263C=94.4 parts water, 4.4 parts hydroxylamine, 1.2 parts oxalic acid dihydrate;

SLX268A=94.3 parts water, 3.5 parts oxalic acid dihydrate, 2.3 parts NH4OH;

SLX268B=90.5 parts water, 5 parts oxalic acid dihydrate, 4.5 parts MEA;

SLX268D=90.5 parts water, 5 parts oxalic acid dihydrate, 4.5 parts MEA, 1 part

NaHSO3;

SLX268E=88.5 parts water, 5 parts oxalic acid dihydrate, 6.5 parts TMAH;

SLX268F=85 parts water, 10 parts oxalic acid dihydrate, 5 parts TMAH (pH=1);

SLX268F1=90 parts H2O, 10 parts oxalic acid dihydrate;

SLX268G=77.5 parts water, 10 parts oxalic acid dihydrate, 12.5 parts TMAH;

SLX268H=80 parts water, 10 parts oxalic acid dihydrate, 10 parts choline hydroxide; and

SLX280=90.1 parts water, 4.6 parts TMAH, 5 parts NaHSO3;

Cu, Al, and Ti substrates were contacted with the various cleaners, and etch rates (ER) were measured as shown in Table 1.

TABLE 1

| | | HSQ | HSQ | | | |
|---|---|---|---|---|---|---|
| | | Thickness | RI | Cu | Al | Ti |
| | Condi- | Change | Change | ER | ER | ER |
| Formulation | tion | (A) | (A) | A/min | A/min | A/min |
| SLX268E | 15 min, | −25 | +0.005 | 17 | 16 | −0.2 |
| | 65 C | | | | | |
| SLX268E | 15 min, | +54 | −0.005 | 17 | 0.3 | 0 |
| | 45 C | | | | | |
| SLX268F | 15 min, | −2 | −0.001 | −4.8 | 3.6 | 0 |
| | 45 C | | | | | |
| SLX268F1 | 15 min, | −19 | −0.002 | 3.8 | 7.4 | 0.1 |
| | 45 C | | | | | |
| SLX268G | 15 min, | −1 | −0.001 | 0.8 | 0.7 | 0 |
| | 45 C | | | | | |

The corrosion rate of SLX268E seems very temperature dependent for HSQ and AL. The SLX268F and SLX268G compositions, which contain about 10% oxalic acid dihydrate, had the lowest overall etch rates.

For SiLK substrates, the following etch and change in RI data in Table 2 was obtained:

TABLE 2

| Compound | Change (angstroms) | Change in RI |
|---|---|---|
| SLX261 (65 C., 15 min.) | 6 | 0.000 |
| SLX263B (65 C., 15 min.) | 8 | 0.000 |
| SLX263C (65 C., 15 min.) | 6 | 0.001 |
| SLX266 (fluoride-based composition, | 28 | −0.003 |
| room temp, 5 min) | | |
| SLX268A (65 C., 15 min.) | 8 | 0.000 |
| SLX268B (65 C., 15 min.) | 3 | 0.000 |
| SLX268E (65 C., 15 min.) | 28 | −0.001 |

The compositions containing fluoride and the composition containing higher amounts of amine performed less satisfactory in that the etch rate was high. The higher TMAH concentrations, i.e., more than about 7% clean more aggressively but etch the substrate.

### EXAMPLE 4

Dow Corning HSQ-XLK substrate was tested with SLX268F at 45 C for 15 minutes, and also with SLX268E at 65 C for 15 minutes. The SLX268F-treated substrate had a thickness change of −14 angstroms and a RI change of 0.003, both of which are commercially acceptable. The SLX268E-treated substrate had a thickness change of −340 angstroms to −440 angstroms, and an RI change of between 0.031 and 0.042, which is not acceptable. Higher concentrations of TMAH increase etch rate, while higher concentrations, i.e., greater than 7%, do not unacceptably increase etch rate. SLX268F was also found to be compatible with copper and aluminum, when immersed at 45 C for 15 minutes, giving an etch rate of −5 angstroms per minute on the copper and 3.6 angstroms per minute on the aluminum.

The cleaner containing 5 wt % oxalic acid dihydrate, 6.5 wt % TMAH, and 88.5 wt % water was also tested on W. L. Gore low-k Speedfilm pattern wafers having unashed, partially ashed, or fully ashed photoresist. The wafers were immersed into the chemistry solution for cleaning for 15 minutes at 65C. Two other cleaning chemistries were tested alongside the chemistry comprising oxalic acid dihydrate, TMAH, and water: ARX60 and KNX009B. ARX60 is a fluoride chemistry. KNX009B is a solvent chemistry comprised of about 10 wt % water. The results are shown in Table 3.

TABLE 3

| | | Thickness Change | |
|---|---|---|---|
| Formulation | Condition | (A) | RI Change (A) |
| SLX268E | 15 min, 65 C. | −14 | 0.003 |
| Prior art - ARX60 | 10 min, RT | −4 | 0.001 |
| KNX009B | 15 min, 85 C. | −1 | 0.002 |

The cleaner SLX268E removed residue but had a higher etch rate than other compositions.

### EXAMPLE 5

A cleaner containing 10 wt % oxalic acid dihydrate, 5 wt % TMAH, and 85 wt % water was tested on a porous low-k dielectric XLK blanket wafer sample from Dow coming due to its high chemical sensitivity and general incompatibility with non-solvent commercial chemistries. The wafers were immersed into the cleaner for cleaning for 15 minutes at 45C.

Ellipsometric measurement showed that the cleaning resulted in very limited changes in thickness and RI. FTIR examination also showed no significant reduction in SiH, changes in SiO, or hydroxyl absorption bands, indicating good compatibility. The results are shown in Table 4.

TABLE 4

| | | Thickness | RI | Thickness | RI | Thickness | RI |
|---|---|---|---|---|---|---|---|
| | | Before | Before | After | After | Change/min | Change |
| Formulation | Condition | (A) | (A) | (A) | (A) | (A) | (A) |
| SLX268F | 15 min, | 4622 | 1.228 | 4608 | 1.231 | −1 | +0.003 |
| | 45 C | | | | | | |

### EXAMPLE 6

Numerous cleaning chemistries were tested on low-k Flowfill blanket wafer samples available commercially from LSI Logic/Trikon to determine chemical compatibility. Changes in thickness and RI were measured after processing and oven baking according to the parameters shown in Table 5.

TABLE 5

| Formulation | Condition |
|---|---|
| Prior art - EKC265 | 30 min, 65 C. |
| Prior art - EKC325 | 30 min, 75 C. |
| Prior art - EKC505 | 30 min, 75 C. |
| Prior art - EKC525 | 15 min, 45 C. |
| Prior art - EKC640 | 10 min, RT |
| Prior art - EKC830 | 30 min, 85 C. |
| Prior art - EKC837 | 30 min, 85 C. |
| Prior art - EKC4000 | 15 min, RT |
| ARX60M | 10 min, RT |
| SLX268B | 15 min, 65 C. |
| SLX268E | 15 min, 65 C. |

ARX60 and ARX60M contain ammonium fluoride, PG, nitric acid, and water. The compositions of these cleaners, as well as other cleaners described herein, are:

| Formulation | Composition | | | |
|---|---|---|---|---|
| EKC16 | MEA | DMSO | | |
| EKC265 | Cat | DGA | HDA | |
| EKC450 | HDA | H2O | PG | |
| EKC505 | NMP | BLO | morpholine | |
| EKC525 | PG | CH | | |
| EKC630 | AF | DMAc | H2O | |
| EKC640 | AF | DMAc | H2O | MEA |
| EKC802 | BLO | DPM acetate | | |
| EKC805 | NMP | HEP | | |
| EKC830 | NMP | DGA | | |
| EKC837 | DGA | HEP | | |
| EKC865 | NMP | HEP | | |
| ARX60M | AF | PG | H2O | HNO3 |
| ARX125M | AF | PG | H2O | MA |
| KNX3 | NMP | Sulfolane | | |
| KNX4 | NMP | Sulfolane | | |

Thickness changes in SLX268B and SLX268E were low and were reduced to very low levels after baking. The results of all chemistries tested are shown in FIGS. 1 and 2.

### EXAMPLE 7

Several cleaning chemistries were tested on AMAT SACVD oxide-based low-k blanket wafers to determine chemical compatibility according to the parameters shown in Table 6.

TABLE 6

| Formulation | Condition |
|---|---|
| Prior art - EKC830 | 30 min, 85 C. |
| Prior art - EKC837 | 30 min, 85 C. |
| Prior art - EKC505 | 30 min, 75 C. |
| Prior art - EKC265 | 30 min, 65 C. |
| Prior art - EKC325 | 30 min, 75 C. |
| Prior art - EKC450 | 15 min, 45 C. |
| Prior art - EKC525 | 15 min, 45 C. |
| Prior art - EKC640 | 10 min, RT |
| Prior art - EKC922 | 30 min, 95 C. |
| Prior art - EKC4000 | 15 min, RT |
| ARX60 | 10 min, RT |
| SLX268E | 15 min, 65 C. |

ARX60 and SLX268E demonstrated a very minimal effect on the wafer material. The results are shown in FIG. 3.

### EXAMPLE 8

Two cleaning chemistries, ARX60 and SLX268E, were tested on LSI Logic metal wafer samples. Sidewall polymers and top surface residues were observed in the unprocessed wafers. Both chemistries cleaned effectively, but some unevenness of Al surface was observed on the sample cleaned with ARX60 indicating that this chemistry attacked Al.

### EXAMPLE 9

The etch rates of numerous cleaning compositions on numerous substrates at a variety of conditions was determined. The data is presented in the tables below, where ARX60M contains AF, PG, nitric acid, and water; ARX125M contains AF, PG, MA, and water; and SLX266 contains hydrofluoric acid, PEl, DMAc, and water.

TABLE 7

| | | | | Etch, |
|---|---|---|---|---|
| | | Contact Time | Contact Temp | angstroms/ |
| Sample | Substrate | (min) | (C.) | min |
| ARX60M | Aluminum | 5 | ambient | 70 |
| ARX125M | Aluminum | 5 | ambient | 100 |
| SLX266 | Aluminum | 5 | ambient | 35 |
| SLX261 | Aluminum | 15 | 65 | 24 |
| SLX263C | Aluminum | 15 | 65 | 13 |
| SLX268A | Aluminum | 15 | 65 | n/a |
| SLX268B | Aluminum | 15 | 65 | 2.0 |
| SLX263B | Aluminum | 15 | 65 | 42 |
| SLX268D | Aluminum | 15 | 65 | n/a |
| SLX268E | Aluminum | 15 | 65 | 16 |

The SLX268B composition, containing 90.5 parts water, 5 parts oxalic acid dihydrate, and 4.5 parts MEA, performed significantly better than all other tested compositions for aluminum substrates. A preferred composition for cleaning aluminum comprises from about 83 to about 95 parts, preferably from about 87 to about 94 parts water; from about 2 to about 10 parts, preferably from about 3 to about 7 parts of oxalic acid dihydrate; and from about 1 to about 10 parts, preferably from about 3 to about 7 parts MEA. The composition SLX268E, containing 88.5 parts water, 5 parts oxalic acid dihydrate, and 6.5 parts TMAH, had a much higher etch rate.

TABLE 8

| | | | | Etch, |
|---|---|---|---|---|
| | | Contact Time | | angstr./ |
| Sample | Substrate | (min) | Contact Temp (C.) | min |
| ARX60M | Copper | 5 | ambient | −30 |
| ARX125M | Copper | 5 | ambient | 1400 |
| SLX266 | Copper | 5 | ambient | −16 |
| SLX261 | Copper | 15 | 65 | >100 |
| SLX263C | Copper | 15 | 65 | >100 |
| SLX268A | Copper | 15 | 65 | n/a |
| SLX268B | Copper | 15 | 65 | 210 |
| SLX263B | Copper | 15 | 65 | >100 |
| SLX268D | Copper | 15 | 65 | 1.3 |
| SLX268E | Copper | 15 | 65 | 17 |

The best of the tested cleaners for copper substrates, SLX268D, had 90.5 parts water, 5 parts oxalic acid dihydrate, 4.5 parts MEA, and 1 part NaHSO3. A preferred composition for cleaning copper comprises from about 83 to about 95 parts, preferably from about 87 to about 94 parts water; from about 2 to about 10 parts, preferably from about 3 to about 7 parts of oxalic acid dihydrate; and from about 1 to about 10 parts, preferably from about 3 to about 7 parts MEA, and from about 0.1 to about 4, preferably from about 0.4 to about 2 parts of a antioxidant, preferably of a sulfite. This is similar to the optimum composition found for the aluminum substrate.

TABLE 9

| | | | | Etch, |
|---|---|---|---|---|
| | | Contact Time | | angstr./ |
| Sample | Substrate | (min) | Contact Temp (C.) | min |
| ARX60M | Titanium | 5 | ambient | 3.2 |
| ARX125M | Titanium | 5 | ambient | 8.4 |
| SLX266 | Titanium | 5 | ambient | 6.4 |
| SLX261 | Titanium | 15 | 65 | 5.4 |
| SLX263C | Titanium | 15 | 65 | 13 |
| SLX268A | Titanium | 15 | 65 | 3.7 |
| SLX268B | Titanium | 15 | 65 | −0.8 |
| SLX263B | Titanium | 15 | 65 | 0.2 |
| SLX268D | Titanium | 15 | 65 | n/a |
| SLX268E | Titanium | 15 | 65 | 0.2 |

From this data it can be seen that several cleaners are compatible with titanium, especially SLX263B and SLX268E. A preferred composition for cleaning titanium comprises from about 83 to about 99 parts, preferably from about 87 to about 98 parts water; from about 0.5 to about 10 parts, preferably from about 1 to about 6 parts of oxalic acid dihydrate; and from about 0.5 to about 10 parts, preferably from about 1 to about 7 parts of a substituted or unsubstituted amine.

TABLE 10

| | | Contact | Contact | Etch, |
|---|---|---|---|---|
| Sample | Substrate | Time(min) | Temp(C.) | angstr./min |
| ARX60M | Titanium oxide | 5 | ambient | 1.0 |
| ARX125M | Titanium oxide | 5 | ambient | 2.4 |
| SLX266 | Titanium oxide | 5 | ambient | 0.2 |
| SLX261 | Titanium oxide | 15 | 65 | 0.1 |
| SLX263C | Titanium oxide | 15 | 65 | 2.9 |
| SLX268A | Titanium oxide | 15 | 65 | 0.1 |
| SLX268B | Titanium oxide | 15 | 65 | 0.3 |
| SLX263B | Titanium oxide | 15 | 65 | 0.7 |
| SLX268D | Titanium oxide | 15 | 65 | n/a |
| SLX268E | Titanium oxide | 15 | 65 | 0.3 |

TABLE 11

| | | | | Etch, |
|---|---|---|---|---|
| | | Contact Time | | angstr./ |
| Sample | Substrate | (min) | Contact Temp (C.) | min |
| ARX60M | Al-ER | 5 | ambient | −14 |
| ARX125M | Al-ER | 5 | ambient | −20 |
| SLX266 | Al-ER | 5 | ambient | −7.2 |
| SLX261 | Al-ER | 15 | 65 | −1.6 |
| SLX263C | Al-ER | 15 | 65 | −0.9 |
| SLX268A | Al-ER | 15 | 65 | n/a |
| SLX268B | Al-ER | 15 | 65 | 0.1 |
| SLX263B | Al-ER | 15 | 65 | 2.8 |
| SLX268D | Al-ER | 15 | 65 | N/A |
| SLX268E | Al-ER | 15 | 65 | −1.1 |

The cleaners of the current invention perform significantly better than the fluoride-(ARX60M) and hydroxylamine-ARX125M) based compositions.

TABLE 12

| | | Contact | Contact | |
|---|---|---|---|---|
| Sample | Substrate | Time(min) | Temp(C.) | Etch, angstr./min |
| ARX60M | Cu-ER | 5 | ambient | 6 |
| ARX125M | Cu-ER | 5 | ambient | −276 |
| SLX266 | Cu-ER | 5 | ambient | 3.2 |
| SLX261 | Cu-ER | 15 | 65 | >100 |
| SLX263C | Cu-ER | 15 | 65 | >100 |
| SLX268A | Cu-ER | 15 | 65 | n/a |
| SLX268B | Cu-ER | 15 | 65 | 14 |
| SLX263B | Cu-ER | 15 | 65 | >100 |
| SLX268D | Cu-ER | 15 | 65 | −0.1 |
| SLX268E | Cu-ER | 15 | 65 | −1.1 |

It was surprising to see high etching on SLX261, SLX263B, and SLX263C. The SLX266, a fluoride-based composition, worked well, but the best cleaner for Copper-ER is one that contains about 5 to about 15 parts oxalic acid dihydrate, from about 5 to about 15 parts of an amine, preferably an alkanolamine, for example choline, and from about 70 parts to about 90 parts water. Advantageously the pH of this composition is between about 3 and about 8, preferably between 3 to 6.

TABLE 13

| | | Contact | Contact | |
|---|---|---|---|---|
| Sample | Substrate | Time(min) | Temp(C.) | Etch, angstr./min |
| ARX60M | Ti-ER | 5 | ambient | −0.6 |
| ARX125M | Ti-ER | 5 | ambient | −1.6 |
| SLX266 | Ti-ER | 5 | ambient | −1.3 |
| SLX261 | Ti-ER | 15 | 65 | −0.4 |
| SLX263C | Ti-ER | 15 | 65 | −0.9 |
| SLX268A | Ti-ER | 15 | 65 | −0.2 |
| SLX268B | Ti-ER | 15 | 65 | −0.1 |
| SLX263B | Ti-ER | 15 | 65 | 0 |
| SLX268D | Ti-ER | 15 | 65 | n/a |
| SLX268E | Ti-ER | 15 | 65 | 0 |

TABLE 14

| | | Contact | Contact | |
|---|---|---|---|---|
| Sample | Substrate | Time(min) | Temp(C.) | Etch, angstr./min |
| ARX60M | TiO2-ER | 5 | ambient | −0.2 |
| ARX125M | TiO2-ER | 5 | ambient | −0.48 |
| SLX266 | TiO2-ER | 5 | ambient | −0.04 |
| SLX261 | TiO2-ER | 15 | 65 | −0.01 |
| SLX263C | TiO2-ER | 15 | 65 | −0.2 |
| SLX268A | TiO2-ER | 15 | 65 | 0 |
| SLX268B | TiO2-ER | 15 | 65 | −0.02 |
| SLX263B | TiO2-ER | 15 | 65 | −0.05 |
| SLX268D | TiO2-ER | 15 | 65 | n/a |
| SLX268E | TiO2-ER | 15 | 65 | −0.02 |

It can be seen that even the most aggressive compositions have little effect on TiO2-ER substrate.

### EXAMPLE 10

Many of the cleaning compositions described above were tested for compatibility with a variety of low-k substrates. The SLX266 was tested by contacting the composition with the substrate at room temperature for 5 minutes, and subsequent evaluation of the substrate by SEM. The contacting time for the remaining compositions was 65 C for 15 minutes. The SLX261, SLX263C, SLX268B, SLX263B, SLX268D, and SLX268E had acceptable compatibility with and cleaned HSQ, with results determined subjectively. The SLX261, SLX263C, SLX268B, SLX263B, and SLX268E had acceptable compatibility with and cleaned NANOGLASS (TM), with results determined subjectively. The SLX266, SLX261, SLX263C, SLX268A, SLX268B, SLX263B, and SLX268E had acceptable compatibility with and cleaned HOSP (TM), with results determined subjectively. The SLX266, SLX261, SLX263C, SLX268A, SLX268B, SLX263B, and SLX268E had acceptable compatibility with and cleaned SiLK (Blanket), with results determined subjectively. In all cases, the subjective judgment was based on whether the interaction caused delamination, and on the changes in thickness and RI of the substrate after exposure to the cleaners.

Etch rate and RI data for SiLK is as follows.

TABLE 15

| | | Contact | Etch, | |
|---|---|---|---|---|
| Sample | Substrate | Time/Temp | angstroms/min | Change in RI |
| ARX60M | SiLK | 5 min/ambient | 0.2 | −0.001 |
| ARX125M | SiLK | 5 min/ambient | −2 | 0.000 |
| SLX266 | SiLK | 5 min/ambient | −14 | −0.003 |
| SLX261 | SiLK | 15 min/65 C. | −0.4 | 0.000 |
| SLX263C | SiLK | 15 min/65 C. | −0.4 | 0.001 |
| SLX268A | SiLK | 15 min/65 C. | −0.5 | 0.000 |
| SLX268B | SiLK | 15 min/65 C. | −0.2 | 0.000 |
| SLX263B | SiLK | 15 min/65 C. | −0.5 | 0.000 |
| SLX268E | SiLK | 15 min/65 C. | −2 | −0.001 |

### EXAMPLE 11

Three cleaning chemistries were tested on two different SiOC low-k wafer samples (#492 and #917) believed to be composed of Black Diamond and Coral. EKC640 (TM) was used to clean wafer sample #492 for 30 minutes at 28 C, with recirculation; and EKC325 (TM) was also used to clean wafer sample #492 for 90 minutes at 75 C. Neither chemistry completely cleaned wafer sample #917. SEM was performed to evaluate cleaning and corrosion effects. ARX60 effectively cleaned wafer sample #492 after being immersed for 5 minutes at ambient temperature. ARX60 did not effectively clean wafer sample #917 under the same conditions and appeared to attack the low-k material of the recess under the hardmask.

Three other compositions were tested with Gore AD and Gore BX SPEEDFILM (TM). ARX60 at room temperature for 10 minutes etched Gore AD 0.4 angstroms per minute with a change in RI of 0.001. SLX268E at 65 C for 15 minutes etched Gore AD 0.9 angstroms per minute with a change in RI of 0.003. KNX009B at 85 C for 15 minutes etched Gore AD 0.1 angstroms per minute with a change in RI of 0.002.

ARX60 at room temperature for 10 minutes etched Gore BX-0.1 angstroms per minute with a change in RI of −0.002. SLX268E at 65 C for 15 minutes etched Gore AD 0.3 angstroms per minute with a change in RI of 0.001. KNX009B at 85 C for 15 minutes etched Gore AD 5 angstroms per minute with a change in RI of 0.055. The SLX268E is compatible with both Gore AD and Gore BX SPEEDFILM (TM).

### EXAMPLE 12

Dow Corning porous HSQ-XLK (TM) was tested with SLX268F at 45 C for 15 minutes, and with SLX268E at 65 C for 15 minutes. The SLX268E gave etch rates in excess of 30 angstroms per minute, and the RI changed by between +0.031 and +0.042. This is poor cleaning compatibility. The SLX268F etched at 0.9 angstroms per minute, and the RI changed +0.003, which is commercially acceptable.

### EXAMPLE 13

Several AMAT Black Diamond pattern wafers were ashed for various lengths of time: 5, 10, 15, and 60 seconds. Two Black Diamond wafer samples (type I and type P) were tested. Four cleaning chemistries were tested for Cu compatibility and degree of resist removal. The results are shown in Tables 16-18.

TABLE 16

| | | | | | Cu |
|---|---|---|---|---|---|
| For- | | Resist | Residue | Oxide | Compat- |
| mulation | Condition | Removal | Cleaning | Hardmask | ibility |
| EKC265 | 15 min, 65 C | marginal | | | |
| EKC640 | 5 min, RT | | | | Y |
| EKC640 | 30 min, RT | | | | Y |
| EKC650 | 30 min, RT | | | | Y |
| BPX3-065 | 30 min, RT | | | | Y |
| BPX3-007 | 30 min, RT | | | | Y |
| ARX60 | 30 min, RT | | Y | damage | Y |
| ARX60 | 10 min, RT | | Y | slight etch | Y |
| EKC525 | 15 min, 45 C | | | | Y |
| EKC525 | 30 min, 65 C | Y | | | Y |
| EKC505 | 15 min, 85 C | | marginal | | Y |
| SLX198 | 10 min, 80 C | Y | Y | damage | |
| SLX198 | 10 min, 65 C | Y | Y | | |
| KNX009 | 10 min, 80 C | Y | | | |
| KNX009B | 15 min, 85 C | Y | Y | | Y |

TABLE 17

| | | Type I | | Type P | |
|---|---|---|---|---|---|
| | | | RI | | RI |
| For- | | Thickness | Change | Thickness | Change |
| mulation | Condition | Change (A) | (A) | Change (A) | (A) |
| EKC265 | 15 min, 65 C | +27 | +0.065 | −174 | +0.033 |
| EKC640 | 5 min, RT | −23 | +0.013 | −42 | +0.006 |
| EKC640 | 30 min, RT | −39 | +0.016 | −52 | +0.009 |
| EKC650 | 30 min, RT | −27 | +0.019 | −70 | +0.012 |
| BPX3-065 | 30 min, RT | −18 | +0.011 | −11 | +0.002 |
| BPX3-007 | 30 min, RT | −43 | +0.015 | −14 | +0.003 |
| ARX60 | 10 min, RT | +33 | +0.011 | −23 | +0.003 |
| EKC525 | 15 min, 45 C | −68 | +0.052 | −75 | +0.013 |
| EKC525 | 30 min, 65 C | −128 | +0.053 | −108 | +0.013 |

TABLE 18

| | | Thickness Change | |
|---|---|---|---|
| Formulation | Condition | (A) | RI Change (A) |
| EKC265* | 15 min, 65 C. | +2 | +0.002 |
| EKC640 | 5 min, RT | +6 | −0.002 |
| EKC505 | 15 min, 85 C. | +2 | −0.001 |
| EKC16 | 15 min, 85 C. | +7 | +0.007 |
| SLX263C | 15 min, 65 C. | +1 | 0 |
| SLX268E | 15 min, 65 C. | +4 | −0.001 |
| EKC525 | 15 min, 45 C. | +126 | −0.029 |
| EKC837 | 15 min, 85 C. | +5 | +0.010 |

*pH greater than 7

It can be seen that SLX263C performed better than a variety of commercial cleaners on Black Diamond (TM) wafers.

### EXAMPLE 14

IMEC HSQ Al patterned wafers were tested with various cleaning chemistries to determine abilities to clean heavy residue and chemical compatibility. EKC265 cleaned very effectively, but showed potential compatibility problems. Fluoride chemistries, both alkaline and acidic, were less effective and were further limited by their etch rates of HSQ and process windows. But SLX261, an aqueous chemistry containing 20 parts hydroxylamine sulfate, cleaned effectively.

Other aqueous chemistries were therefore tested which included combinations of various species with potential chelation/redox ability, such as HDC, MEA, TMAH, oxalic acid, and combinations thereof. Most of these chemistries showed good compatibility with HSQ, indicated by small changes in thickness and RI after processing, and as shown by SEM photos. Severe Al etch was observed with some combinations, but this is not believed to be caused by wet chemistries since the etch was highly anisotropic and very limited lateral etch was observed. A severe wet Al etch would be isotropic and result in significant lateral and vertical etch of this magnitude. Therefore, this severe Al etch is believed to be a function of plasma overetch when residue was removed.

Many of these aqueous chemistries were also compatible with other types of low-k dielectrics such as Nanoglass, HOSP, and SiLK. The chemistries showed much lower changes in thickness of SiLK when compared with completely solvent-based or semi-aqueous chemistries, indicating possible lower solvent absorption. One formulation, SLX268E, was also found be somewhat Cu-compatible. The compositions contained:

The SLX261 and SLX263 chemistries showed no etching or corrosion of HSQ wafers when immersed for 15 minutes at 65 C. The wafers each increased in size (by less than 2 angstroms per minute), and the RI was 1.390-1.391. The SLX 263 etches TiN/Ti layers (in vias) but does not etch aluminum.

Additional results are shown in Table 19.

TABLE 19

| | | | | | | Clean |
|---|---|---|---|---|---|---|
| | Nanoglass | HOSP | HSQ | SiLK | Cu | HSQ/Al |
| Formulation | Blanket | Blanket | Blanket | Blanket | Blanket | Pattern |
| SLX261 | OK | OK | OK | OK | | OK |
| SLX263B | OK | OK | OK | OK | | OK |
| SLX263C | OK | OK | | OK | | OK |
| SLX268A | | OK | | OK | not | not |
| | | | | | tested | tested |
| SLX268B | OK | OK | OK | OK | | OK |
| SLX268E | OK | OK | OK | OK | OK | OK |

Compositions of this invention containing MEA, TMAH, or a mixture thereof are preferred over compositions containing ammonium hydroxide for use on copper substrates. A preferred composition for use on copper substrates comprises the SLX268B composition additionally comprising an antioxidant, preferably between about 0.05% to about 4%, for example from about 0.5% to about 1.5% of a sulfite or bisulfite. Samples of copper wafer immersed in this composition for 15 minutes at 65 C showed almost no copper etch. SLX268E, comtaining 6.5 parts TMAH, 5 parts oxalic acid dihydrate, and 89 parts water had excellent cleaning and exhibited low copper etch and compatibility with low-k substrates.

As used herein, low-k materials or substrates include HSQ, HOSP, Nanoglass, Silk, totally SI-based, totally C-based, hybrid, and porous materials.

### EXAMPLE 15

A cleaning composition, SLX277, which contained 90 parts water, 3.6 parts oxalic acid, and 7.71 parts of 30% ammonium hydroxide in water, was tested on a TSMC HSQ blanket and via by immersion for 15 minutes at 65 C. The RI was 1.400, and the wafer gained thickness (less than 1 angstrom per minute). The composition showed satisfactory etch in the via structure, and it cleaned effectively.

### EXAMPLE 16

Three cleaning chemistries were tested to determine compatibility with blanket etched Nanoglass wafers. The degree of etch increased from wafer #3 to #4 to #8. EKC265 thickness change was reduced in the more etched wafers; and this chemistry showed some passivation effect as it is more aggressive toward this material. Both thickness and RI changes were significantly reduced for etched wafers. The results are shown in Table 20.

TABLE 20

| Formulation | Condition | Wafer | Thickness Change (A) |
|---|---|---|---|
| EKC265* | 15 min, 65 C. | Etch-03-I | −85 |
| EKC505 | 15 min, 85 C. | Etch-03-II | −20 |
| EKC640 | 5 min, RT | Etch-03-III | +33 |
| EKC265* | 15 min, 65 C. | Etch-04-I | −57 |
| EKC505 | 15 min, 85 C. | Etch-04-II | −74 |
| EKC640 | 5 min, RT | Etch-04-III | −7 |
| EKC265* | 15 min, 65 C. | Etch-08-I | −401 |
| EKC505 | 15 min, 85 C. | Etch-08-II | +89 |
| EKC640 | 5 min, RT | Etch-08-III | +7 |

*pH greater than 7

Numerous commercially available chemistries (EKC16, EKC265, EKC505, EKC525, EKC640, EKC800, and EKC837) were also tested on additional wafers for dielectric property measurement.

### EXAMPLE 17

ReadRite NiFe and Cu blanket wafers were cleaned with numerous cleaning chemistries to determine changes in thickness and roughness. The results are shown in Table 21.

TABLE 21

| | | | Average | Thickness |
|---|---|---|---|---|
| | | | Roughness | Change |
| Formulation | Condition | Wafer | Change (A) | (A) |
| EKC450 | 30 min, 55 C. | K01905 | −0.9 | −570 |
| | | NiFe | | |
| EKC505 | 30 min, 85 C. | K01905 | +4.1 | −343 |
| | | NiFe | | |
| EKC525 | 30 min, 55 C. | K01905 | −0.9 | −20 |
| | | NiFe | | |
| EKC640 | 15 min, RT | K01905 | +6.3 | −648 |
| | | NiFe | | |
| EKC450 | 30 min, 55 C. | S20095 Cu | +4.1 | −64 |
| EKC505 | 30 min, 85 C. | S20095 Cu | −3.1 | 335 |
| EKC525 | 30 min, 55 C. | S20095 Cu | −5 | 528 |
| EKC640 | 15 min, RT | S20095 Cu | −1.4 | 499 |

A RIE pattern wafer was also cleaned with EKC450, EKC525, and EKC505. EKC450 and EKC525 were somewhat effective, but not as effective as EKC505.

### EXAMPLE 18

A wafer having an oxide/HSQ/TiN/Al structure was purposely overetched to about 180 nm into the aluminum in order to simulate a difficult via cleaning situation. Several cleaning chemistries were tested, including a few fluoride-based solutions such as EKC630, EKC640, ARX60M, and ARX125M that did not clean effectively. All wafer samples were immersed for 5 minutes at room temperature to minimize etch on HSQ. SLX261, an aqueous hydroxylamine chemistry, was found to clean effectively with good compatibility. The results are shown in Tables 22 and 23.

TABLE 22

| Formulation | Condition | HSQ Pattern |
|---|---|---|
| EKC265 | 15 min, 65 C. | Clean |
| EKC525 | 15 min, 45 C. | Severe Al corrosion |
| EKC630 | 5 min, RT | Not clean |
| EKC640 | 5 min, RT | Not clean |
| ARX60M | 5 min, RT | Not clean |
| ARX125M | 5 min, RT | Not clean |
| SLX261 | 15 min, 65 C. | Clean |

TABLE 23

| | | HSQ Blanket | HSQ Blanket RI |
|---|---|---|---|
| Formulation | Condition | Thickness Change (A) | Change (A) |
| ARX60M | 5 min, RT | −21 | 0.002 |
| ARX125M | 5 min, RT | −26 | 0.004 |
| SLX261 | 15 min, 65 C. | 7 | 0.001 |

### EXAMPLE 19

Several cleaning compositions were tested on Allied Signal Nanoglass (TM) wafers. The results are shown in Table 24.

TABLE 24

| | | Nanoglass k2.2 | | Nanoglass k2.5 | |
|---|---|---|---|---|---|
| | | Thickness | RI | | RI |
| | | Change | Change | Thickness | Change |
| Formulation | Condition | (A) | (A) | Change (A) | (A) |
| EKC630 | 5 min, RT | 9 | −0.018 | 5 | −0.026 |
| EKC640 | 5 min, RT | 32 | −0.013 | 38 | −0.018 |
| ARX60M | 5 min, RT | 3 | −0.004 | −25 | −0.001 |
| ARX125M | 5 min, RT | −14 | −0.008 | −25 | −0.007 |
| SLX261 | 15 min, 65 C | −3 | −0.005 | 12 | −0.005 |
| SLX263C | 15 min, 65 C | 18 | −0.008 | 31 | −0.015 |
| EKC505 | 15 min, 85 C | 51 | 0.010 | N/A | N/A |
| EKC830 | 15 min, 85 C | 52 | 0.011 | N/A | N/A |
| KNX3 | 30 min, 85 C | 20 | 0.005 | N/A | N/A |
| KNX4 | 30 min, 85 C | 25 | 0.005 | N/A | N/A |
| EKC16 | 30 min, 85 C | 39 | 0.003 | N/A | N/A |

Several compositions of the present invention were sufficiently compatible with Nanoglass K2.2 (TM).

### EXAMPLE 20

Numerous cleaning chemistries were tested on Allied Signal HOSP wafers, including aqueous hydroxylamine (SLX261 and SLX63C) and fluoride-based chemistries (ARX60M, ARX125M, and SLX266) that showed lower changes in thickness and RI in general, indicating some compatibility with HOSP material. The results are shown in Table 25.

TABLE 25

| | | Thickness Change | |
|---|---|---|---|
| Formulation | Condition | (A) | RI Change |
| EKC265 | 30 min, 65 C. | −57 | 0.010 |
| EKC630 | 5 min, RT | −18 | −0.081 |
| EKC630 | 10 min, RT | −168 | −0.080 |
| EKC640 | 5 min, RT | −98 | 0.012 |
| ARX60M | 5 min, RT | −11 | 0.004 |

### EXAMPLE 21

Three cleaning chemistries were tested on Allied Signal Nanoglass wafers to determine chemical compatibility. IR spectra showed some changes in the wafers, mostly in the increase of moisture content and some solvent absorption. The results are shown in Table 26.

TABLE 26

| | | | RI @ | | RI Change |
|---|---|---|---|---|---|
| For- | | Thickness | 633 nm | Thickness | @ 633 nm |
| mulation | Condition | (A) | (A) | Change (A) | (A) |
| EKC265 | 15 min, 65 C | 6996 | 1.193 | −624 | −0.019 |
| EKC505 | 15 min, 85 C | 7571 | 1.221 | −49 | +0.009 |
| EKC830 | 15 min, 85 C | 7326 | 1.234 | −294 | +0.022 |

### EXAMPLE 22

A group of cleaning chemistries was tested on TSMC HSQ wafers to determine compatibility with Cu and Al. SEM was performed to evaluate cleaning and corrosion effects. The results are shown in Table 27.

TABLE 27

| | | | | Thick- | Thick- | |
|---|---|---|---|---|---|---|
| | | | | ness | ness | Etch |
| | | | Thickness | After | Change | Rate |
| Formulation | Condition | Metal | Before (A) | (A) | (A) | (A/min) |
| ARX60M | 5 min, RT | Cu | 17894 | 17862 | −32 | 6 |
| ARX125M | 5 min, RT | Cu | 17380 | 17424 | 44 | N/A |
| ARX60M | 5 min, RT | Al | 10019 | 10016 | −3 | <1 |
| ARX125M | 5 min, RT | Al | 9981 | 9863 | −118 | 24 |

### EXAMPLE 23

One cleaning chemistry, EKC265, was tested in various conditions for chemical compatibility on TI FSG wafers. Thickness and RI @ 633 nm were measured with a dual wavelength Gaertner L2W16 ellipsometer. The values were averaged from 9-point scans of individual specimens. FTIR spectra were generated with a BioRad FT175C spectrophotometer. The results are shown in Table 28.

TABLE 28

| | | | | RI | |
|---|---|---|---|---|---|
| | Thickness | Thickness | Thickness | Before | RI After |
| Condition | Before (A) | After (A) | Change (A) | (A) | (A) |
| 10 min, 65 C | 5295 | 5292 | −3 | 1.429 | 1.428 |
| 20 min, 65 C | 5361 | 5354 | −7 | 1.428 | 1.427 |
| 30 min, 65 C | 5141 | 5127 | −14 | 1.432 | 1.432 |
| 10 min, 75 C | 5163 | 5164 | 1 | 1.431 | 1.431 |
| 20 min, 75 C | 5360 | 5352 | −8 | 1.427 | 1.427 |
| 30 min, 75 C | 5252 | 5248 | −4 | 1.430 | 1.429 |

### EXAMPLE 24

Several cleaning chemistries, including a fluoride chemistry (HTXO13A), were tested on IMEC low-k pattern wafers with an oxide/HSQ/oxide structure in order to remove a thin layer of photoresist on the top surface without damaging the HSQ film. The results are shown in Table 29.

TABLE 29

| Formulation | Condition | Stripping |
|---|---|---|
| EKC505 | 15 min, 85 C | incomplete |
| EKC830 | 15 min, 85 C | incomplete |
| EKC505 | 30 min, 85 C | incomplete |
| EKC830 | 30 min, 85 C | incomplete |
| EKC802 | 30 min, 85 C | incomplete |
| EKC805 | 30 min, 85 C | incomplete |
| EKC837 | 30 min, 85 C | incomplete |
| EKC865 | 30 min, 85 C | incomplete |
| EKC830 | 60 min, 85 C | incomplete |
| EKC837 | 60 min, 85 C | incomplete |
| HTX013A | 5 min, RT | incomplete |

### EXAMPLE 25

One cleaning chemistry (SMS-50L) was tested for its compatibility with various low-k dielectrics. Blanket wafer samples were immersed in SMS-50L for 20 minutes at 65 C, then immersed in IPA for 5 minutes, then rinsed with DIW, and blown dry with nitrogen gas. The samples were then examined for thickness changes (by ellipsometry or SpectraMap) and structural changes (by IR). This chemistry was found to be somewhat incompatible with most Si-based materials, such as HSQ, LOSP, and PureSpin. Significant thickness and RI changes were observed. IR spectra also indicated possible structural changes. Organic low-k materials showed some increase in thickness, indicating possible solvent absorption. No delamination was observed. The results are shown in Table 30.

TABLE 30

| | Before | | After | | Change | |
|---|---|---|---|---|---|---|
| | Thickness | RI | Thickness | RI | Thickness | RI |
| Material | (A) | (A) | (A) | (A) | (A) | (A) |
| HSQ | 5046 | 1.383 | 4903 | 1.407 | −143 | +0.024 |
| MSQ | 5567 | 1.409 | 5617 | 1.408 | +50 | −0.001 |
| SiLK | 6077 | 1.663 | 6135 | 1.653 | +58 | −0.010 |
| FLARE | 8134 | N/A | 8176 | N/A | +42 | N/A |
| BCB | 10367 | N/A | 10646 | N/A | +279 | N/A |
| Parylene | 6683 | N/A | 6713 | N/A | +30 | N/A |
| HOSP | 4155 | 1.392 | 4179 | 1.401 | +27 | +0.009 |
| LOSP | 5225 | 1.373 | 5113 | 1.454 | −112 | +0.081 |
| PureSpin | 4055 | 1.385 | 3704 | 1.458 | −351 | +0.073 |
| FSG | 5283 | 1.426 | 5266 | 1.426 | −17 | 0.000 |

### EXAMPLE 26

A test was conducted on various low-k dielectric wafer samples (SiLK, FLARE, BCB, PAE, FPI) to study the feasibility of using hot water to screen sample variability. The wafer samples were immersed in water at 55 C for 15 minutes, then inspected visually for delamination and examined by IR. These samples were low-k dielectric thin films coated on oxide. Though prone to delamination, especially in aggressive cleaning chemistries, none of the samples demonstrated delamination or structural changes in this hot water test, showing delamination was the result of the compositions used.

### EXAMPLE 27

Several cleaning chemistries were tested for compatibility and residue removal on 4200 angstrom thick TSMC HSQ wafers. Of those tested, the results for the three chemistries shown in Table 31 demonstrated the best combination of compatibility, residue removal, and metal corrosion.

TABLE 31

| Formulation | Condition | HSQ Thickness (A) | HSQ RI (A) |
|---|---|---|---|
| ARX60M | 5 min, RT | 4068 | 1.402 |
| SLX261 | 15 min, 65 C | 4228 | 1.391 |
| SLX263 | 15 min, 65 C | 4212 | 1.390 |

The HSQ film had an initial thickness of about 4200 A and an RI of 1.390. As the data showed, ARX60M, an acidic fluoride chemistry modified from ARX60, exhibited limited effects on the HSQ film. ARX60M also showed highly effective residue removal, indicating a good balance of compatibility and cleaning. For fluoride chemistries, process temperature and time must be maintained low because of their aggressiveness toward HSQ. Therefore, the compatibility window for HSQ in terms of process temperature and time is somewhat narrow.

Two other cleaning chemistries generated satisfactory results. SLX261, an acidic hydroxylamine chemistry, caused little change in the HSQ, and the compatibility window was reasonably wide. Al corrosion appeared to be negligible based on SEM photos.

SLX263, a hydroxylamine/chelator chemistry, performed similarly to SKX261 in terms of compatibility, compatibility window, and metal corrosion. Both compositions effectively removed residues from via sidewall and bottom, and were evaluated using SEM.

### EXAMPLE 28

Several cleaning chemistries were tested on a pattern wafer with a structure of oxide/SiLK/nitride. The wafers were immersed in: EKC450 for 15 minutes at 45 C, EKC525 for 15 minutes at 45 C, and SLX231 for 15 minutes at 35 C. The testing primarily demonstrated effects on hardmask adhesion.

EKC525 showed no general delamination, but adhesion strength was reduced in some areas. EKC450 showed no delamination. SLX231 performed similarly to EKC525 and EKC450, but showed less of an effect on adhesion.

### EXAMPLE 29

Three cleaning chemistries (EKC450, EKC525, and SLX231) were tested on Schumacher PAE blanket wafer samples with a PAE/oxide structure. All of the chemistries had either Cu or oxide hardmask compatibility or both. None showed delamination or significant changes in PAE IR spectra, indicating no catastrophic effect on adhesion strength.

### EXAMPLE 30

A fluoride/solvent chemistry, SLX267, was tested on ruthenium oxide pattern wafer samples for 5 minutes at 55 C. The chemistry cleaned effectively, but much particle redeposit was also observed. In addition, the solution appeared to be near its limit of solid solubility.

### EXAMPLE 31

Two cleaning chemistries, SLX169 and SLX170, were tested for SEMATECH DPS etch residue removal. Sample wafers were immersed in: SLX169 for 30 minutes at 65 C, and SLX170 for 30 minutes at 75 C. Both chemistries appeared to be too strong for the samples because severe corrosion and etch-out of Al was observed.

### EXAMPLE 32

Various cleaning chemistries were tested on a National Semiconductor via (TEOS/low-k) structure. When tested on cleaved samples, SLX168, a non-hydroxylamine chemistry containing water, oxalic acid dihydrate, and ammonia hydroxide (pH about 9.5), demonstrated no delamination, and cleaning seemed acceptable. When later tested on whole 8″ wafers, cleaning appeared unsatisfactory because some vias were not cleaned completely, as confirmed by SEM photos.

SLX172, a hydroxylamine/propylene glycol based formulation, yielded satisfactory results including complete cleaning and no delamination. Also, the process window of this chemistry appeared to be relatively wide. Cleaning for 15 minutes at 35 C showed no delamination and no significant difference in cleaning from those wafers cleaned for 15 minutes at 45 C. After whole 8″ wafer testing, the 15 minute/45 C condition was adopted to accommodate potential variation in residue level across the wafer and to ensure complete whole wafer cleaning.

### EXAMPLE 33

An 8″ low-k blanket wafer and two patterned samples were immersed in EKC830 for 30 minutes at 85 C, then rinsed with EKC4000 for 5 minutes, and then processed with a 5 cycle QDR. The wafer was examined to determine if EKC830 could feasibly strip an I-line resist expected to be used to pattern the low-k structure. Since this low-k material was a carbon containing silicon material, dry stripping (ashing) was not possible and wet stripped needed to be implemented.

A 49-point FTIR mapping conducted before and after processing showed that cross wafer uniformity of the blanket wafer was good. The low-k material appeared to be compatible with EKC830 since major IR absorptions did not show significant changes.

### EXAMPLE 34

Several cleaning chemistries were tested on Dow Corning/Fujitsu FOx blanket/pattern wafers. The compositions tested are shown in Table 32.

TABLE 32
Sample Composition (in parts by weight)

SLX160: 2.5 BC, 97.5 water, (pH 8.45)
SLX164: 85 water, 10 DGA, 5 CAT, 0.1 ABF, 6.2 CA.
SLX165: 85 water, 10 DGA, 5 CAT, 0.1 ABF, 5.8 CA.
SLX161: 85 water, 10 DGA, 5 CAT, 5.8 CA.
SLX163: 85 water, 10 DGA, 5 CAT, 0.1 ABF, 0.5 PVA
SLX164; 85 water, 10 DGA, 5 CAT, 0.1 ABF, 6.2 CA (pH 6).
SLX165; 85 water, 10 DGA, 5 CAT, 0.1 ABF, 5.8 CA (pH 8.9).
SLX166; 85 water, 10 DGA, 0.1 ABF, 5.6 CA (pH 7.1).
SLX167; 85 water, 10 DGA, 0.1 ABF, 5 CA (pH 9.1).
SLX168: 85 water, 10 DGA, 5 CAT, 6.9 CA.
SLX175: 80 water, 10 DGA, 5 CAT, 6 CA, 0.1 ABF.
SLX172: 47.5 water, 2.5 HDA, 50 PG.
SLX173: 2.5 HDA, 97.5 water, 0.17 VA, (pH 8.25).
SLX237: 47.5 DGA, 47.5 HEP, 5 water, 0.1 ABF.
SLX212: 31.5 NMP, 45 MORPHOLINE, 13.5 BLO, 10 water, 0.2 ABF.
SLX255: 10 MEA, 10 CA, 85 water.
SLX259: 10 TMAH, 10 CA, 85 water.

The results of contacting the Dow Corning/Fujitsu FOx blanket/pattern with these compositions was as follows.

SLX164 gave a RI@633 nm 1.371, cleans, doesn't nOF clean.

SLX165 gave a RI@633 nm 1.382, cleans, nOF cleans.

SLX166 gave a RI@633 nm 1.326, slight cleans, doesn't No-F clean.

SLX167 gave a RI@633 nm 1.371, doesn't clean, doesn't nOF clean.

SLX172 had no delamination, cleaned vias at 35 C for 15 Minutes, and can be rinsed with DI or 1% CA. The parameters for the SLX172 test were pH 8.8, RI@633 nm 1.411, contact at 45 C for 15 min, DI rinse, D:Fujitsu ashed, D Fujitsu stripped.

SLX173 had an RI@633 nm of 1.407, after contacted at 45 C for 15 min, DI rinse, D:Fujitsu ashed, D Fujitsu stripped.

SLX160 had an RI@633 nm of 1.37, after contacting at 45 C for 15 min, DI rinse, D:Fujitsu ashed, D Fujitsu stripped

When used on TSMC HSQ, under-cured substrate, the following results were observed.

SLX 237 contacted at 65 C for 15 min gives RI@633 nm of 1.398 and left Al residual.

SLX212 contacted at 65 C for 10 min gives almost complete stripping.

SLX255 contacted at 65 C for 15 min gives RI@633 nm of 1.418, slight OH on IR spectra.

SLX259 contacted at 65 C for 15 min gives RI@633 nm of 1.413, slight OH on IR spectra.

Most hydroxylamine containing chemistries behaved in a similar manner in terms of compatibility, with different degrees of hydrolysis of FOx, change of refractive index, and film thickness loss. In cleaners for use with Fox substrates, it is preferred that the cleaner contain less than 2%, preferably less than 1%, for example no, hydroxylamines or salts thereof.

Some formulations showed significant retention of SiH (>70% vs. 16% of EKC265) and some cleaning ability in the ashed/FOx double layer structure. The non-hydroxylamine formulations, showed limited or no reaction with the dielectric material and high retention of refractive index and film thickness. Much higher retention of SiH (all >80%, several at 100%) was also observed.

Some formulations also demonstrated cleaning ability in the ashed sample. The rating of cleaning efficiency, however, was not conclusive because little residue was seen in the vias and comparison was highly subjective.

### EXAMPLE 35

A group of cleaning chemistries were tested on Allied Signal FLARE (TM) material to determine adhesion strength on various substrates. The FLARE coating appeared to be highly anisotropic with heavy radial straitation.

TABLE 33

| Formulation | Condition |
|---|---|
| EKC265 | 30 min, 65 C |
| EKC270 | 30 min, 65 C |
| EKC800 | 30 min, 85 C |
| EKC830, 30 min, 85 C | 30 min, 85 C |

All chemistries were followed by a 5 minute EPA rinse and a 5 cycle QDR. Adhesion to titanium nitride substrate was good, but some discoloration was observed indicating the possibility of post-processing film non-uniformity. Adhesion to bare silicon was also good, and no delamination was observed.

On nitride substrate, EKC270 and EKC830 caused delamination while EKC265 and EKC800 did not. On silane oxide and TEOS substrates, only EKC800 caused no delamination. FTIR analysis indicated that there was no significant chemical change on the non-delaminated samples.

### EXAMPLE 36

Several cleaning chemistries were tested for delamination and via cleaning on low-k dielectric SiLK wafers. Hydroxylamine chemistries (such as EKC265, EKC935, and EKC287) tended to cause some delamination. In terms of cleaning ability, however, EKC265 at 55 C for 15 and 25 minutes was very effective. Reducing the processing time for EKC265 to 5 minutes eliminated delamination.

Stripper chemistries (such as EKC830 and ED3001) were ineffective in cleaning. Additionally, EKC830 caused some delamination. NOE chemistries were ineffective in cleaning via bottom at room temperature and caused delamination at high temperature. Choline chemistries performed similarly to NOE.

A non-hydroxylamine chemistry, SLX168, demonstrated no delamination and acceptable cleaning. The process window, however, was narrow and the uniformity of cleaning across the wafer was unclear.

### EXAMPLE 37

A group of cleaning chemistries were tested on low-k blanket wafers that were broken into quarter pieces. The wafer pieces were processed to determine dielectric measurement. All chemistries were followed by a 5 minute IPA rinse and a 5 cycle QDR.

TABLE 34

| Formulation | Condition |
|---|---|
| EKC265 | 30 min, 55 C |
| EKC265 | 30 min, 65 C |
| EKC270 | 30 min, 65 C |
| EKC830 | 30 min, 85 C |

Thickness and RI were measured before and after processing. SEM inspection showed that in one type of structure, the upper half of sidewall was covered with residue while the lower half was severely straitated.

EKC265, EKC270, and EKC830 were also tested at 55/65 C and 75/85 C for 30/60 minutes. The hardmask over the low-k dielectric appeared to be affected by each of these three chemistries, and especially by EKC265 and EKC270 at high temperature over a long process time. Regarding cleaning efficiency, EKC265 removed most residue at 55C/30 min, but did not appear to reduce straitation. EKC830 at 75C/30 min removed all residue and somewhat reduced straitation. SLX168 at 45C/15 min removed some residue and appeared to reduce straitation considerably.

### EXAMPLE 38

Numerous cleaning chemistries were tested on Dow-Coming/Fujitsu FOx pattern wafers. For the wet-stripped and ashed wafers, several residue cleaning chemistries (such as SLX164, SLX165, SLX166, and SLX 167) were tested. These chemistries were somewhat compatible with FOx.

### EXAMPLE 39

There were a series of tests to determine HSQ, metal (Al, Cu, Ti) compatibility of

SLX268E, SLX268F, SL x 268F1, and SLX268G.

SLX268F 10 wt % oxalic acid (dihydate)+5 wt % TMAH (25% aq. SiHi)+85 wt % H2O

SLX268F=10 wt % oxalic acid (dihydrate)+90 wt % H2O SLX268G=10 wt % oxalic acid +50 wt % TMAH (25% aq. soln)

TABLE 35

| | | Thickness | | Thickness | | Thickness | |
|---|---|---|---|---|---|---|---|
| HSQ | Condition | Before | RI Before | After | RI After | Change | RI Change |
| SLX268E | 45 C./15′ | 6124 | 1.368 | 6178 | 1.363 | +54 | −0.005 |
| SLX268F | 45 C./15′ | 6173 | 1.365 | 6171 | 1.366 | −2 | −0.001 |
| SLX268F1 | 45 C./15′ | 6120 | 1.369 | 6101 | 1.371 | −19 | −0.002 |
| SLX268G | 45 C./15′ | 6071 | 1.372 | 6070 | 1.373 | −1 | −0.001 |

TABLE 36

| | | | Thickness | | Thickness | Thickness | |
|---|---|---|---|---|---|---|---|
| Cu | Condition | RS Before | Before | RS After | After | Change | ER |
| SLX268E | 45 C./15′ | 0.01065650 | 15953 | 0.01083350 | 15692 | −261 | 17 |
| SLX268F | 45 C./15′ | 0.01107837 | 15345 | 0.01102688 | 15417 | 72 | −4.8 |
| SLX268F1 | 45 C./15′ | 0.01057837 | 16071 | 0.01061650 | 16013 | −58 | 3.8 |
| SLX268G | 45 C./15′ | 0.01072763 | 15847 | 0.01073625 | 15834 | −13 | 0.8 |

Use 170 as Cu resistivity.

TABLE 37

| | | | Thickness | | Thickness | Thickness | |
|---|---|---|---|---|---|---|---|
| Al | Condition | RS Before | Before | RS After | After | Change | ER |
| SLX268E | 45 C./15′ | 0.0326575 | 9492 | 0.03267500 | 9487 | −5 | 0.3 |
| SLX268F | 45 C./15′ | 0.0329625 | 9405 | 0.03315250 | 9351 | −54 | 3.6 |
| SLX268F1 | 45 C./15′ | 0.0327950 | 9453 | 0.03318500 | 9342 | −111 | 7.4 |
| SLX268G | 45 C./15′ | 0.0321000 | 9657 | 0.03213375 | 9647 | −10 | 0.7 |

10000A Al is assumed to have ohm/sq. of 0.031

We claim:

1. A semiaqueous cleaning composition for use with aluminum, copper, and low-k substrates, the cleaning composition comprising between about 1% to about 30% oxalic acid dihydrate, between about 0.1% and about 30% of an amine, and water, wherein the cleaning composition contains less than about 0.5% fluorine-containing compounds and less than 0.5% peroxides.

2. The semiaqueous cleaning composition of claim 1 additionally comprising a second organic acid, an inorganic acid, or mixture thereof, wherein the pH of the composition is between about 2 and 12.

3. The semiaqueous cleaning composition of claim 2 wherein the organic acid is selected from dicarboxylic, monocarboxylic, hydroxy-carboxylic, amino-carboxylic, sulfano-carboxylic, and amino-sulfano acids.

4. The semiaqueous cleaning composition of claim 1 additionally comprising at least one hydroxylamine.

5. The semiaqueous cleaning composition of claim 1 additionally comprising benzotriazole, thiourea, ammonium bisulfite, choline bisulfite, propylene glycol, glycerol, sorbitol, gelatine, starch, phosphoric acid, silicic acid polyethylene oxide, polyethylene imine, or mixture thereof in an amount sufficient to reduce etching of the substrate contacting the cleaner.

6. The semiaqueous cleaning composition of claim 1 additionally comprising at least one chelating agent, and comprises less than about 0.1% of organic solvents.

7. The semiaqueous cleaning composition of claim 1 wherein the chelating agent is selected from dicarboxylic acids, hydroxy-carboxylic acids, amino-carboxylic acids, diamine, polyalcohol, polyethylene oxide and polyamine/imine.

8. The semiaqueous cleaning composition of claim 1 additionally comprising between 350.01% and 1% of polyvinyl alcohol, polyethylene oxide, polyethylene imine, polyalcohol, polyether, polyamine/imine, or mixture thereof.

9. The semiaqueous cleaning composition of claim 1 further comprising between about 0.01% and about 10% of an oxygen scavenger.

10. The semiaqueous cleaning composition of claim 9 wherein the oxygen scavenger is a sulfite.

11. The semiaqueous cleaning composition of claim 1 wherein the oxalic acid dihydrate concentration is between about 2% and about 20%, and wherein the pH is between about 4 and 7.

12. The semiaqueous cleaning composition of claim 2 further comprising a second organic acid, wherein the total organic acid concentration is less than about 20% total organic acids, and wherein the oxalic acid dihydrate concentration is between about 4% and about 12%.

13. The semiaqueous cleaning composition of claim 12 wherein the second organic acid comprises citric acid, formic acid, or a mixture thereof.

14. The semiaqueous cleaning composition of claim 2 comprising between about 0.01% and about 6% of an inorganic acid.

15. The semiaqueous cleaning composition of claim 1 wherein the amines comprise one or more alkanolamines in am amount ranging from about 1% and about 15%.

16. The semiaqueous cleaning composition of claim 1 comprising between about 3% and about 15% of oxalic acid; between about 3% and about 20% of a second organic acid; between about 3% and about 30% of an amine; and between about 1% and about 15% of a chelating agent.

17. The semiaqueous cleaning composition of claim 1 comprising about 3% to about 8% by weight oxalic acid dihydrate, about 22% to about 30% tetramethylammonium hydroxide, and about 64% to about 74% water.

18. The semiaqueous cleaning composition of claim 2 comprising about 2% to about 8% oxalic acid dihydrate; about 7% to about 13% formic acid; about 1% to about 15% of ammonium hydroxide, an amine, or mixture thereof; and about 72% to about 90% water.

19. The semiaqueous cleaning composition of claim 1 which comprises from about 83 to about 95% water; from about 2 to about 10% of oxalic acid dihydrate; and from about 1 to about 10% monoethanolamine.

20. The semiaqueous cleaning composition of claim 1 which comprises from about 83 to about 95 parts water; from about 2 to about 10 parts of oxalic acid dihydrate; from about 1 to about 10 parts monoethanolamine, and from about 0.1 to about 4 parts of a sulfite.

21. The semiaqueous cleaning composition of claim 1 which comprises from about 87% to about 98% water; from about 1% to about 6% parts of oxalic acid dihydrate; and from about 1% to about 7% of a substituted or unsubstituted amine.

22. The semiaqueous cleaning composition of claim 1 which comprises from about 5% to about 15% oxalic acid dihydrate, from about 5% to about 15% of choline, and from about 70 parts to about 90 parts water, wherein the pH of this composition is between about 3 and about 8.

23. The semiaqueous cleaning composition of claim 1 which comprises about 7% to about 13% of oxalic acid dihydrate, about 5% to about 13% tetramethylammonium hydroxide, and between 0% to about 5% of a sulfite.

24. The semiaqueous cleaning composition of claim 1 which comprises about 8 to about 12% oxalic acid dihydate; about 3 to about 7% wt % tetramethylammonium hydroxide; and about 80 to about 90% water.

25. A semiaqueous cleaning composition for use with aluminum, copper, and low-k substrates, the cleaning composition comprising between about 7% to about 13% oxalic acid dihydrate, about 10% to about 15% tetramethylammonium hydroxide, and about 65% to about 85% water.

26. The semiaqueous cleaning composition of claim 1 which comprises about 87 to about 94% water; about 3 to about 7% oxalic acid dihydrate; about 3 to about 7% monoethanolamine, and about 0.1 to about 4% of a sulfite salt.

27. The semiaqueous cleaning composition of claim 1 wherein the amine comprises diglycolamine.

28. The semiaqueous cleaning composition of claim 2 wherein the second organic acid comprises citric acid, and additionally comprising from about 0.01% to about 0.4% of a fluoride ion, wherein the pH of the composition is between about 4 and about 10.

29. The semiaqueous cleaning composition of claim 1 comprising between about 2 and about 9% oxalic acid dihydrate, between about 2 and about 15% formic acid, between about 0.5 and about 5% ammonium hydroxide, and between about 71 and about 95% water.

30. A method of cleaning a semiconductor substrate comprising:
contacting the substrate with a semiaqueous cleaning composition of claim 1 for between about 5 minutes and about 60 minutes and at a temperature of between about 20 C to about 85 C; and
rinsing the cleaned substrate to remove the cleaning composition.

31. A method of cleaning a semiconductor substrate comprising:
contacting the substrate with a semiaqueous cleaning composition of claim 2 for between about 5 minutes and about 60 minutes and at a temperature of between about 20 C to about 85 C; and
rinsing the cleaned substrate to remove the cleaning composition.

32. A method of cleaning a semiconductor substrate comprising:
contacting the substrate with a semiaqueous cleaning composition comprising between about 7% to about 13% oxalic acid dihydrate, about 2% to about 8% tetramethylammonium hydroxide, and about 80% to about 90% water for between about 5 minutes and about 60 minutes and at a temperature of between about 20 C to about 85 C; and
rinsing the cleaned substrate to remove the cleaning composition.

33. A method of cleaning a semiconductor substrate comprising:
contacting the substrate with a semiaqueous cleaning composition comprising between about 1% to about 30% oxalic acid dihydrate, between about 0.1% and about 10% of ammonia hydroxide, and water for between about 5 minutes and about 60 minutes and at a temperature of between about 20 C to about 85 C; and
rinsing the cleaned substrate to remove the cleaning composition.

34. A method of cleaning a semiconductor substrate comprising:
contacting the substrate with a semiaqueous cleaning composition comprising between about 1% to about 30% oxalic acid dihydrate, between about 0.1% and about 25% of hydroxyamines or salts thereof, and water, wherein the cleaning composition contains less than about 0.5% fluorine-containing compounds and less than 0.5% peroxides for between about 5 minutes and about 60 minutes and at a temperature of between about 20 C to about 85 C; and
rinsing the cleaned substrate to remove the cleaning composition.

35. A method of cleaning a semiconductor substrate comprising:
contacting the substrate with a semiaqueous cleaning composition comprising about 3% to about 15% oxalic acid dihydrate, wherein the pH of the composition is between about 1 and about 12, for between about 5 minutes and about 60 minutes and at a temperature of between about 20 C to about 85 C; and
rinsing the cleaned substrate to remove the cleaning composition.
